(19) United States
(12) Patent Application Publication
(10) Pub. No.: US 2025/0021388 A1
(43) Pub. Date: Jan. 16, 2025

(54) USING MACHINE LEARNING FOR EXECUTING BATCH JOBS IN DISTRIBUTED CLOUD ENVIRONMENT

(71) Applicant: Oracle Financial Services Software Limited, Mumbai (IN)

(72) Inventors: Shivam Agrahari, Bansai (IN); Veresh Jain, Bengaluru (IN); Phanindra Choda, Bengaluru (IN); Rahul Kiran Gaddam, Bengaluru (IN); Harish Macha, Bengaluru (IN); Pritam Jena, Bengaluru (IN); Unmesh Gopalkrishna Pai, Mumbai (IN)

(73) Assignee: Oracle Financial Services Software Limited, Mumbai (IN)

(21) Appl. No.: 18/352,422

(22) Filed: Jul. 14, 2023

(51) Int. Cl. G06F 9/50

(52) U.S. Cl. CPC G06F 9/5027

(57) ABSTRACT

A method includes estimating a number of threads to execute batch job within maximum completion time by executing a thread estimation algorithm. Executing the thread estimation algorithm includes: determining, using an ML model, a collection of one or more combinations, each including an estimated number of threads and an actual completion time for processing the batch job using the estimated number of threads, the actual completion time being less than or equal to the maximum completion time, and saving the collection including the one or more combinations in a list of threads and completion times. The list of threads and completion times is used to select, based on a list of cloud virtual machines available for use, an optimal virtual machine or an optimal virtual machine combination, the optimal virtual machine or the optimal virtual machine combination being capable of executing the batch job within the maximum completion time.

### FIELD

The present disclosure relates generally to artificial intelligence techniques, and more particularly, to estimating cloud resources for batch processing using machine learning.

### BACKGROUND

Machine learning (ML) is an area of artificial intelligence (AI) where computers have the capability to learn without being explicitly programmed. There are different types of ML techniques including supervised learning techniques, unsupervised learning techniques, and others. In a supervised learning technique, an ML model is trained using training data, where the training data includes multiple training examples, each training example including an input and a known output corresponding to the input. In an unsupervised learning technique, an ML model or algorithm is provided with unlabeled data, and is tasked to analyze and find patterns in the unlabeled data. The examples of unsupervised learning technique are dimension reduction and clustering.

As a part of the training, the model being trained learns a function that maps the inputs in the training data to their corresponding known outputs. After a model has been adequately trained using the training data, it can then be used for making output predictions for new inputs where the outputs are not known. This is often referred to as the inferencing phase.

Models trained using supervised learning techniques are typically used to solve two types of tasks: a classification task or a regression task. For a classification task, as a part of the training, a model learns a function that maps an input to an output value, where the output value is from a discrete set of classes (or class labels). Accordingly, in a classification problem, the model learns to map an input to one or more of the classes in a set of discrete classes. For a regression task, the model learns a function that maps inputs to continuous output values (e.g., continuous real numbers).

In computing, the batch processing refers to the execution of groups of programs, i.e., jobs, without user interaction. For example, many businesses use the batch processing to do a relatively large amount of the computer processing.

Additionally, some businesses cannot perform and/or complete some of the tasks in real-time, due to the nature of the task. For example, in the banking industry, some tasks can only be completed at the end of the particular day, e.g., interest calculation at the end of a quarter. Accordingly, the work to be completed at the certain time period, e.g., after hours, is executed by clubbing multiple jobs together, e.g., by the batch processing.

Accordingly, for some businesses, the batch processing is a time sensitive process that needs to be completed at the certain time period by a deadline, e.g., completed after the business hours and before the midnight. Due to the time sensitivity of the process, such businesses try to ensure that enough computational resources are available during the certain time period.

However, it is difficult to ensure that the sufficient available resources satisfy the requirements for the batch processing without reserving excessive resources. This might lead to overloading computer networks and unnecessary waste of computational resources.

### SUMMARY

Techniques disclosed herein relate generally to using artificial intelligence techniques. More specifically and without limitation, techniques disclosed herein relate to a novel approach for using machine learning to estimate cloud resources for executing batch jobs. Various embodiments are described herein to illustrate various features. These embodiments include various methods, systems, non-transitory computer-readable storage media storing programs, code, or instructions executable by one or more processors, and the like.

In various embodiments, a computer-implemented method performed by a computer system is provided. The computer-implemented method includes estimating a number of threads to execute a batch job within a maximum completion time by executing a thread estimation algorithm, the executing the thread estimation algorithm including: determining, using a machine learning (ML) model, a collection of one or more combinations, each of the one or more combinations including an estimated number of threads and an actual completion time for processing a total number of records of the batch job using the estimated number of threads, the actual completion time being less than or equal to the maximum completion time; and saving the collection including the one or more combinations in a list of threads and completion times, where the list of threads and completion times is used to select, based on a list of cloud virtual machines available for use, an optimal virtual machine or an optimal virtual machine combination, the optimal virtual machine or the optimal virtual machine combination being capable of executing the batch job within the maximum completion time.

In some embodiments, the executing the thread estimation algorithm further includes: for each number of threads among a plurality of numbers of threads between 2 and a predetermined maximum number of threads, iteratively performing: determining a thread initialization time based on a current number of threads for processing the batch job in a current iteration among a plurality of iterations, determining a process execution time using the maximum completion time and the thread initialization time, providing, as an input to the ML model, the process execution time, based on the input process execution time, obtaining, as an output of the ML model, a predicted number of records to be processed by the current number of threads, determining whether the predicted number of records is greater than or equal to an expected number of records processable using the current number of threads, and if the predicted number of records is greater than or equal to the expected number of records, determining, by using the ML model, the actual completion time to process the expected number of records, and saving, in the list of threads and completion times, the current number of threads in correspondence to the actual completion time of the batch job, where the current number of threads corresponds to the estimated number of threads of the current iteration, and outputting the list of threads and completion times based on the plurality of iterations performed for the plurality of numbers of threads.

In some embodiments, determining, by using the ML model, the actual completion time to process the expected number of records includes: providing, as an input to the ML model, the expected number of records to be processed in the current iteration, the expected number of records being calculated by dividing the total number of records by the current number of threads; obtaining, as an output the ML model, a running time corresponding to the expected number of records; and calculating the actual completion time by adding the thread initialization time to the running time output by the ML model.

In some embodiments, the computer-implemented method further includes: selecting, from the list of cloud virtual machines, a plurality of most efficient single virtual machines to include a most efficient single virtual machine available for use in each of a plurality of configurations, each of the plurality of configurations corresponding to a number of cores per single virtual machine; and arranging the plurality of most efficient single virtual machines in a list of the plurality of most efficient single virtual machines.

In some embodiments, the one or more combinations in the list of threads and completion times include one combination, and the computer-implemented method further includes: determining a virtual machine collection including a plurality of efficient virtual resources, each of the plurality of efficient virtual resources includes one from among a single virtual machine and a virtual machine combination that are determined from the list of the plurality of most efficient single virtual machines, where each of the plurality of efficient virtual resources has a number of cores greater than or equal to a total number of cores to execute the batch job within the maximum completion time; saving, in a list of efficient virtual resources, the plurality of efficient virtual resources in an order of decreasing efficiency; and selecting the optimal virtual machine or the optimal virtual machine combination as a most efficient virtual resource from the list of efficient virtual resources.

In some embodiments, the selecting the optimal virtual machine or the optimal virtual machine combination as the most efficient virtual resource includes determining a virtual machine or a virtual machine combination having a lowest cost from the list of efficient virtual resources.

In some embodiments, the one or more combinations in the list of threads and completion times include a plurality of combinations, and the computer-implemented method further includes: for each of the plurality of combinations, iteratively performing: determining a virtual machine collection including a plurality of efficient virtual resources, each of the plurality of efficient virtual resources includes one from among a single virtual machine and a virtual machine combination that are determined from the list of the plurality of most efficient single virtual machines, where each of the plurality of efficient virtual resources has a number of cores greater than or equal to a total number of cores to execute the batch job within the maximum completion time; saving, in a list of efficient virtual resources, the plurality of efficient virtual resources in an order of decreasing efficiency; and selecting, as the optimal virtual machine or the optimal virtual machine combination, a most efficient virtual resource based on a plurality of lists of efficient virtual resources obtained based on performing a plurality of iterations.

In some embodiments, the computer-implemented method further includes: generating a training dataset using training data related to a historical batch job of a certain type; and training an input model using the training dataset to generate the ML model for processing the batch job of the certain type.

In some embodiments, the ML model includes a regression model.

In various embodiments, a computer-implemented method performed by a computer system is provided. The computer-implemented method includes obtaining a list of threads and completion times for processing a batch job within a maximum completion time, the list of threads and completion times including a collection of one or more combinations, each of the one or more combinations including an estimated number of threads and an actual completion time for processing a total number of records of the batch job using the estimated number of threads; and selecting, from a list of cloud virtual machines available for use, an optimal virtual machine or an optimal virtual machine combination using the list of threads and completion times, the optimal virtual machine or the optimal virtual machine combination being capable of executing the batch job within the maximum completion time.

In some embodiments, the selecting the optimal virtual machine or the optimal virtual machine combination further includes: selecting, from the list of cloud virtual machines, a plurality of most efficient single virtual machines to include a most efficient single virtual machine available for use in each of a plurality of configurations, each of the plurality of configurations corresponding to a number of cores per single virtual machine; and arranging the plurality of most efficient single virtual machines in a list of the plurality of most efficient single virtual machines.

In some embodiments, the one or more combinations in the list of threads and completion times include one combination, and the selecting the optimal virtual machine or the optimal virtual machine combination further includes: determining a virtual machine collection including a plurality of efficient virtual resources, each of the plurality of efficient virtual resources includes one from among a single virtual machine and a virtual machine combination that are determined from the list of the plurality of most efficient single virtual machines, where each of the plurality of efficient virtual resources has a number of cores greater than or equal to a total number of cores to execute the batch job within the maximum completion time; saving, in a list of efficient virtual resources, the plurality of efficient virtual resources in an order of decreasing efficiency; and selecting the optimal virtual machine or the optimal virtual machine combination as a most efficient virtual resource from the list of efficient virtual resources.

In some embodiments, the selecting the optimal virtual machine or the optimal virtual machine combination as the most efficient virtual resource includes determining a virtual machine or a virtual machine combination having a lowest cost from the list of efficient virtual resources.

In some embodiments, the one or more combinations in the list of threads and completion times include a plurality of combinations, and the selecting the optimal virtual machine or the optimal virtual machine combination further includes: for each of the plurality of combinations, iteratively performing: determining a virtual machine collection including a plurality of efficient virtual resources, each of the plurality of efficient virtual resources includes one from among a single virtual machine and a virtual machine combination that are determined from the list of the plurality of most efficient single virtual machines, where each of the plurality of efficient virtual resources has a number of cores greater than or equal to a total number of cores to execute the batch job within the maximum completion time; saving, in a list of efficient virtual resources, the plurality of efficient virtual resources in an order of decreasing efficiency; and selecting, as the optimal virtual machine or the optimal virtual machine combination, a most efficient virtual resource based on a plurality of lists of efficient virtual resources obtained based on performing a plurality of iterations.

In some embodiments, the obtaining the list of threads and completion times further includes: for each number of threads among a plurality of numbers of threads between 2 and a predetermined maximum number of threads, iteratively performing: determining a thread initialization time based on a current number of threads for processing the batch job in a current iteration among a plurality of iterations, determining a process execution time using the maximum completion time and the thread initialization time, providing, as an input to a machine learning (ML) model, the process execution time, based on the input process execution time, obtaining, as an output of the ML model, a predicted number of records to be processed by the current number of threads, determining whether the predicted number of records is greater than or equal to an expected number of records processable using the current number of threads, and if the predicted number of records is greater than or equal to the expected number of records, determining, by using the ML model, the actual completion time to process the expected number of records, and saving, in the list of threads and completion times, the current number of threads in correspondence to the actual completion time of the batch job, where the current number of threads corresponds to the estimated number of threads of the current iteration, and outputting the list of threads and completion times based on the plurality of iterations performed for the plurality of numbers of threads.

In some embodiments, the determining, by using the ML model, the actual completion time to process the expected number of records includes: providing, as an input to the ML model, the expected number of records to be processed in the current iteration that is calculated by dividing the total number of records by the current number of threads; obtaining, as an output the ML model, a running time corresponding to the expected number of records; and calculating the actual completion time by adding the thread initialization time to the running time output by the ML model.

In some embodiments, the computer-implemented method further includes: generating a training dataset using training data related to a historical batch job of a certain type; and training an input model using the training dataset to generate the ML model for processing the batch job of the certain type.

In some embodiments, the ML model includes a regression model.

Some embodiments of the present disclosure include a system including one or more data processors. In some embodiments, the system includes a non-transitory computer-readable storage medium containing instructions which, when executed on the one or more data processors, cause the one or more data processors to perform part or all of one or more methods and/or part or all of one or more processes disclosed herein.

Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1A is a simplified block diagram of a resource estimation system according to various embodiments.

FIG. 1B is a simplified block diagram of a resource estimation system in a distributed computing environment according to various embodiments.

FIG. 1C is a simplified block diagram of a resource estimation system in a cloud service provider (CSP) infrastructure according to various embodiments.

FIG. 2A illustrates an example of a portion of the training data, according to various embodiments.

FIG. 2B illustrates a dependency between the running time and the number of records for a batch job, according to various embodiments.

FIG. 2C illustrates a dependency between the running time and the number of records for a batch job, according to various embodiments.

FIG. 2D illustrates a batch job execution graph, according to various embodiments.

FIG. 2E shows a portion of the training data, according to certain embodiments.

FIG. 2F shows an example of a regression model, according to various embodiments.

FIG. 2G shows an example of a processing performed by the resource estimation system, according to various embodiments.

FIG. 3 depicts processing performed by the resource estimation system according to various embodiments.

FIGS. 4A, 4B, 4C, 4D, 4E, and 4F illustrate examples of operations performed by the resource estimation system, according to various embodiments.

FIG. 5 depicts processing performed by the resource estimation system according to various embodiments.

FIG. 6 depicts a block diagram of a model training and deployment system in accordance with various embodiments.

FIG. 7A depicts processing performed by the resource estimation system according to various embodiments.

FIG. 7B depicts processing performed by the resource estimation system according to various embodiments.

FIG. 8 is a block diagram illustrating one pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### I. INTRODUCTION

The present disclosure relates generally to using artificial intelligence techniques. More specifically and without limitation, techniques disclosed herein relate to a novel approach for using machine learning to estimate cloud resources for executing batch jobs.

In computing, the batch processing refers to the execution of groups of programs, i.e., jobs, without user interaction. Many businesses use the batch processing to do a relatively large amount of the computer processing. For example, batch jobs may be back-end processes that automatically run at a certain time. The batch jobs may include business processes (such as billing and delinquency processing) and housekeeping tasks (such as application aging and application purging). More examples of the batch jobs are provided below.

Batch jobs can be set up to be performed on a daily, weekly, monthly, and ad-hoc basis. Batch job has multiple records to be processed via the same pipeline. The time taken for batch jobs changes and in general scales with the number of records.

Some businesses cannot perform and/or complete some of the tasks in real-time, due to the nature of the task. For example, in the banking industry, some tasks can only be completed at the end of the particular day, e.g., interest calculation at the end of a quarter. Such tasks, e.g., tasks to be completed at the certain time period, are executed by the batch processing. Accordingly, for some businesses, the batch processing is a time sensitive process that needs to be completed at the certain time period by a deadline, e.g., completed after the business hours and before the midnight.

Due to the time sensitivity of the process, the businesses try to ensure that enough computational resources are available during the certain time period. For example, the interest calculation may be performed for a great number of customers (e.g., 1,000,000, . . . 7,000,000, . . . , etc.) at the end of the quarter (e.g., end of the day on March 31) and the interest needs to be shown for each customer's account next day (e.g., morning of April 1).

However, it is difficult to ensure that the sufficient available resources satisfy the requirements for the batch processing without reserving excessive resources. This leads to burdening and overloading computer networks and waste of computational resources.

The techniques described herein overcome the above-mentioned problems and other problems.

The disclosed techniques are for using machine learning to secure adequate resources for the batch jobs of different types such that the batch jobs can be executed within the allotted execution completion time by using optimal computing resources selected with great accuracy to avoid excess, thereby alleviating the burden on the computer networks and preserving computational resources.

Since the computational resources needed may be ad-hoc basis and varying based on the number of records being processed, the disclosed methods operate in the cloud-based environment. Cloud computing, e.g., Infrastructure-as-a-Service (IaaS), enables customers to obtain the computing resources (in the form of virtual machines) in an on-demand basis and provides computational elasticity.

The disclosed techniques optimize the allocation of computing resources by using machine learning, to find the most efficient resource(s) to execute the batch job. The most efficient resource(s) may both be the fastest and the most economical resource that is capable of executing the batch job within the maximum completion time. As such, the disclosed techniques improve functioning of the computer networks by conserving computational resources.

The disclosed techniques are capable of executing the “end of the day jobs” in a timebound manner and in a cost-effective manner, by determining the number of virtual machines that are needed to run the job by using the machine learning to prevent overloading of the computer networks.

In the cloud environment, the cost of the computing machine is changing depending on the time and other factors such as a geographic region. The disclosed techniques can, based on the job, determine the number of threads, determine how many virtual machines are needed to run the threads, and determine which geographic region or which data center has the virtual machines so that the job can be executed in a real-time manner, within the requisite time frame without consuming unnecessary computing resources.

In various embodiments, the described techniques may estimate a number of threads to execute a batch job within a maximum completion time and select, from a list of cloud virtual machines available for use, an optimal virtual machine or an optimal virtual machine combination for executing the batch job within the maximum completion time using the estimated number of threads.

In various embodiments, the described techniques can estimate a number of threads to execute a batch job by using a machine learning (ML) model, where a plurality of ML models for different types of the batch jobs using the data of the historical batch jobs may be built.

In various embodiments, the described techniques can ensure that the batch job can be executed in a real-time manner using optimal virtual machines, an availability of which is updated in near real-time.

As a result of the processing by the described techniques, while the execution of the given batch job may be surely secured within the maximum completion time, the most efficient computing resources are used, without the need to make available the computing resources in excess or start securing the additional computing resources in the middle of the batch job execution to complete the batch job on time.

### II. RESOURCE ESTIMATION SYSTEM

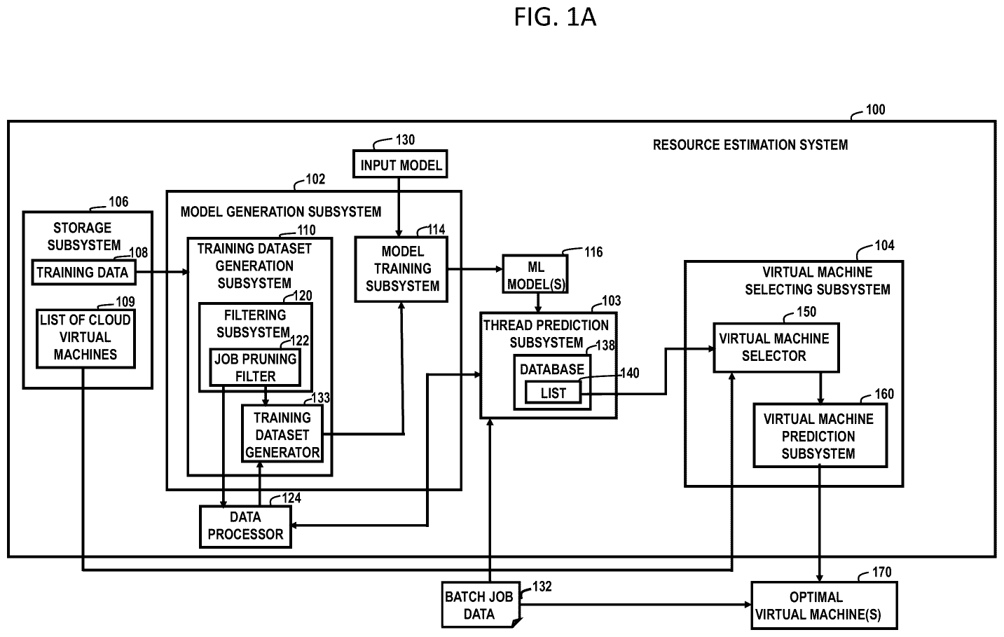

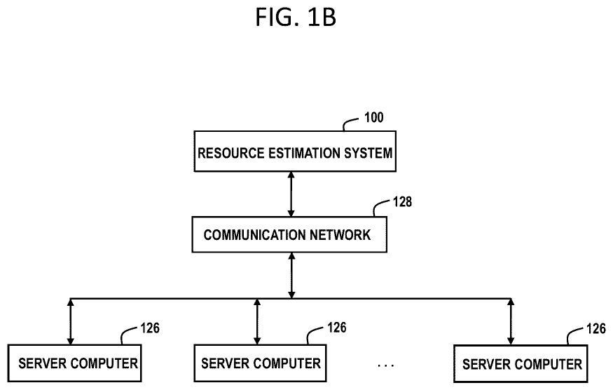

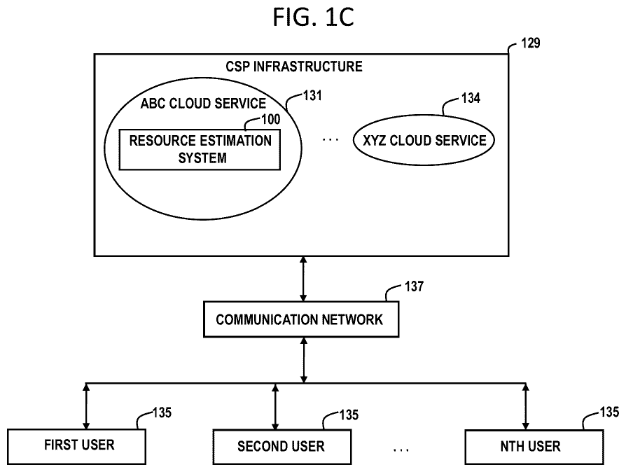

FIG. 1A is a simplified block diagram of a resource estimation system 100 according to certain embodiments. The resource estimation system 100 may be implemented using one or more computer systems, each computer system having one or more processors. The resource estimation system 100 may include multiple components and subsystems communicatively coupled to each other via one or more communication mechanisms. For example, in the embodiment depicted in FIG. 1A, the resource estimation system 100 includes a model generation subsystem 102, a thread prediction subsystem 103, and a virtual machine (VM) selecting subsystem 104.

These subsystems may be implemented as one or more computer systems. The systems, subsystems, and other components depicted in FIG. 1A may be implemented in software (e.g., code, instructions, program) executed by one or more processing units (e.g., processors, cores) of the respective systems, using hardware, or combinations thereof. The software may be stored on a non-transitory storage medium (e.g., on a memory device).

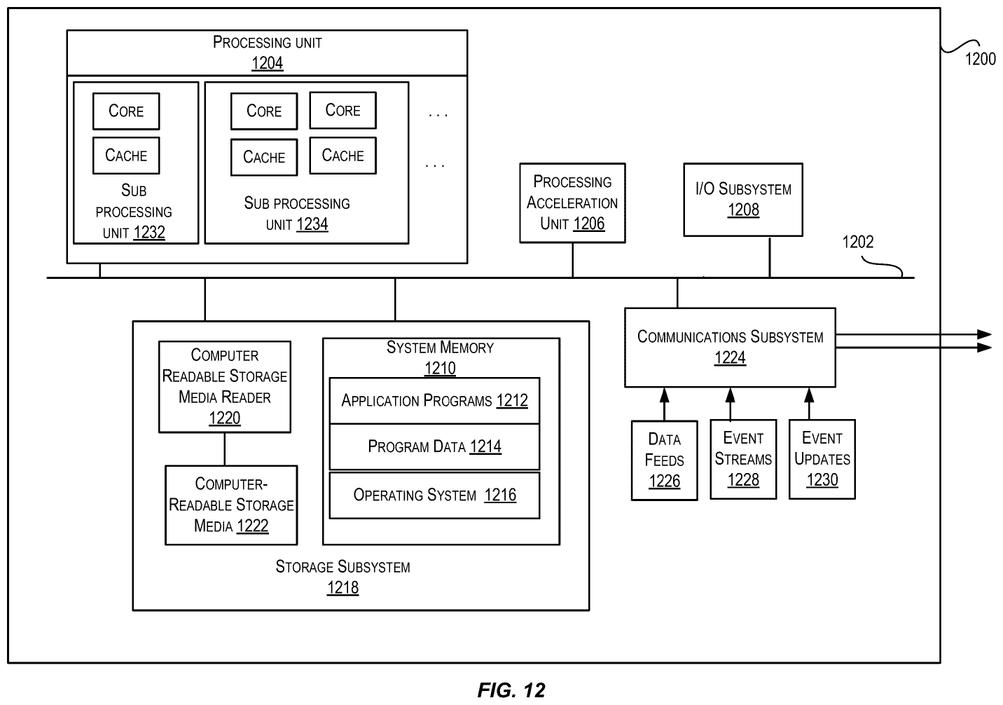

The resource estimation system 100 depicted in FIG. 1A is merely an example and is not intended to unduly limit the scope of embodiments. Many variations, alternatives, and modifications are possible. For example, in some implementations, the resource estimation system 100 may have more or fewer subsystems or components than those shown in FIG. 1A, may combine two or more subsystems, or may have a different configuration or arrangement of subsystems. The resource estimation system 100 and subsystems depicted in FIG. 1A may be implemented using one or more computer systems, such as the computer system depicted in FIG. 12.

As shown in FIG. 1A, the resource estimation system 100 also includes a storage subsystem 106 that may store the various data constructs and programs used by the resource estimation system 100. For example, the storage subsystem 106 may store training data 108, e.g., historical batch job data, used by the resource estimation system 100. However, this is not intended to be limiting. For example, the training data 108 can be stored in another memory location, internal or external to the resource estimation system 100.

In addition to the training data 108, other data used by the resource estimation system 100 or generated by the resource estimation system 100 as a part of its functioning may be stored in the storage subsystem 106. For example, a list 109 of cloud virtual machines may also be stored in the storage subsystem 106.

As shown in FIG. 1B, the resource estimation system 100 can be provided as a part of a distributed computing environment, where the resource estimation system 100 is connected to one or more server computers 126 via a communication network 128. An example of a distributed computing environment is depicted in FIG. 12 and described in detail below.

As shown in FIG. 1C, the resource estimation system 100 may be a part of a CSP infrastructure 129 provided by a CSP for providing one or more cloud services. For example, the one or more cloud services may include ABC cloud service 131 to XYZ cloud service 134 connected to computers of one or more users 135 via a communication network 137. For example, the resource estimation system 100 may be a part of the ABC cloud service 131.

An example of a cloud infrastructure architecture provided by the CSP is depicted in FIGS. 8-11 and described in detail below.

In embodiments, the resource estimation system 100 can, based on the batch job, determine a number of threads, determine how many virtual machines are needed to run the threads, and determine which geographic region or which data center has the virtual machines so that the job can be executed in a real-time. In embodiments, the resource estimation system 100 performs a multi-stage processing. At the first processing stage, the resource estimation system 100 is configured to estimate a number of threads for performing a batch job within a given maximum completion time. At the second processing stage, the resource estimation system 100 is configured to predict an optimal virtual machine or an optimal virtual machine combination to process a given batch job.

### A. Thread Estimation

As described in detail below, the thread prediction subsystem 103 estimates the number of threads to complete the batch job in time which is less than or equal to a maximum completion time, where, for a given maximum completion time, there can be different sets of threads that can satisfy the constraint of completing the batch job within the maximum completion time.

For example, if a number of threads is X, the batch job can be completed in Y amount of time, where Y is less than or equal to the maximum completion time. If the number of threads is greater than X, than the batch job can be completed in an amount of time that is less than Y.

Each pair of a number of threads and corresponding completion time is a constraint that serves as an input to the virtual machine selecting subsystem 104. The objective of the virtual machine selecting subsystem 104 is then to find the most efficient virtual machine or the most efficient virtual machine combination, provided as an input a minimum number of cores. In some embodiments, the most efficient virtual machine or the most efficient virtual machine combination may refer to the most economical solution, e.g., the lowest cost solution. In some embodiments, the most efficient virtual machine or the most efficient virtual machine combination may refer to the fastest solution. In some embodiments, the most efficient virtual machine or the most efficient virtual machine combination may refer to the most economical solution that is also the fastest.

### 1. Training Dataset Generation

In certain implementations, the model generation subsystem 102 may include a training dataset generation subsystem 110 and a model training subsystem 114. The training dataset generation subsystem 110 is configured to receive the training data 108 as an input, and perform certain processing on the training data 108 to generate one or more training datasets. Each training dataset may include training datapoints, where each training datapoint is associated with a number of records processed and a completion time for a specific type of historical batch job. The training dataset(s) may be then used by the model training subsystem 114 to generate one or more machine learning (ML) models 116.

In some embodiments, the training dataset generation subsystem 110 may obtain the training data 108 from the storage subsystem 106 or another memory location (e.g., an external storage medium accessible to the resource estimation system 100). The training data 108 may be a collection of historical data that is labeled and provides information regarding resources used to process a plurality of historical batch jobs of different types. For example, each of the historical batch jobs may be associated with a job code (e.g., a job identifier) that may indicate a type of that batch job. The plurality of historical batch jobs may include batch jobs of one type or of a plurality of types that represent information collected over a time period depending on a periodicity of a batch job execution. For example, the time period may be from few weeks to few years.

Examples of types of the batch jobs include interest calculation for the customers of a financial institution, a task when the leave days for everybody in the company need to be updated in the system for the next month on the last day of the current month, generation and/or printing of periodic reports, calculation of total sales for the day, etc.

For example, the training data 108 may contain, for each of the historical batch jobs, historical information including batch job attributes. For example, the batch job attributes include one or more of a number of threads, a completion time, a number of virtual machines, a number of CPUs, the geographic region used, costs, etc. In certain embodiments, the historical batch jobs may be arranged in groups, where each batch job group corresponds to the same batch job type, e.g., interest calculation, and includes historical batch jobs having diverse information, e.g., having at least one different batch job attribute. As an example, one batch job group may include two or more batch jobs having different number of records, different number of threads, and/or different completion time.

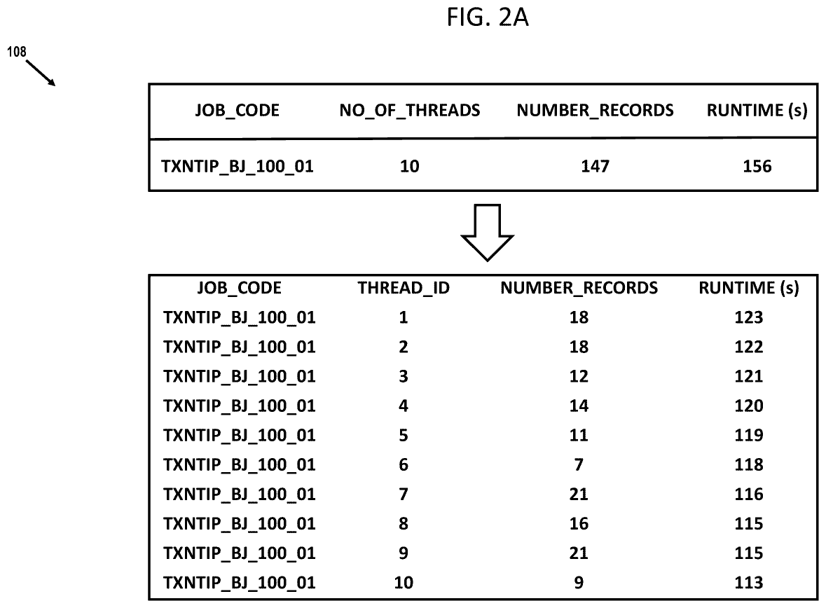

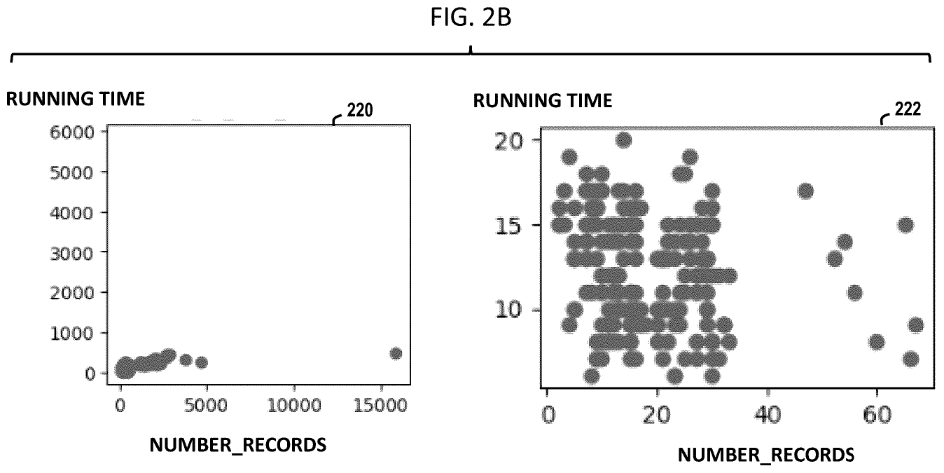

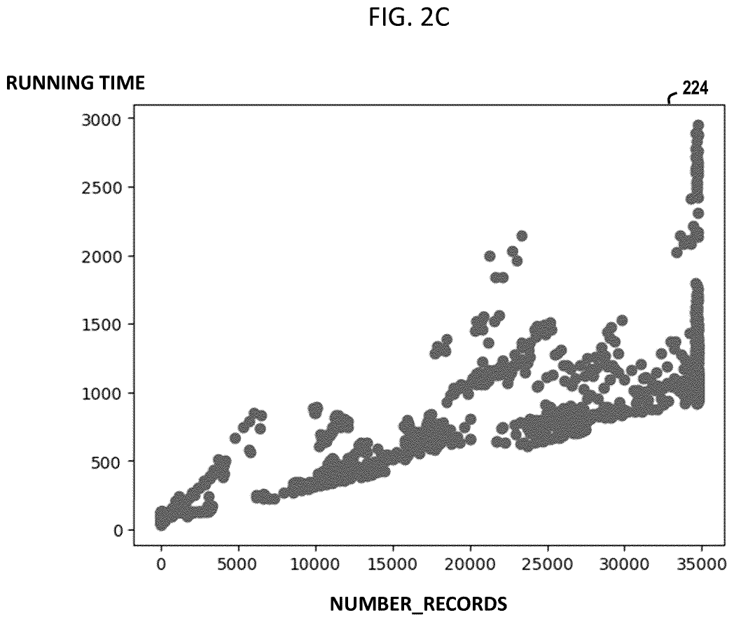

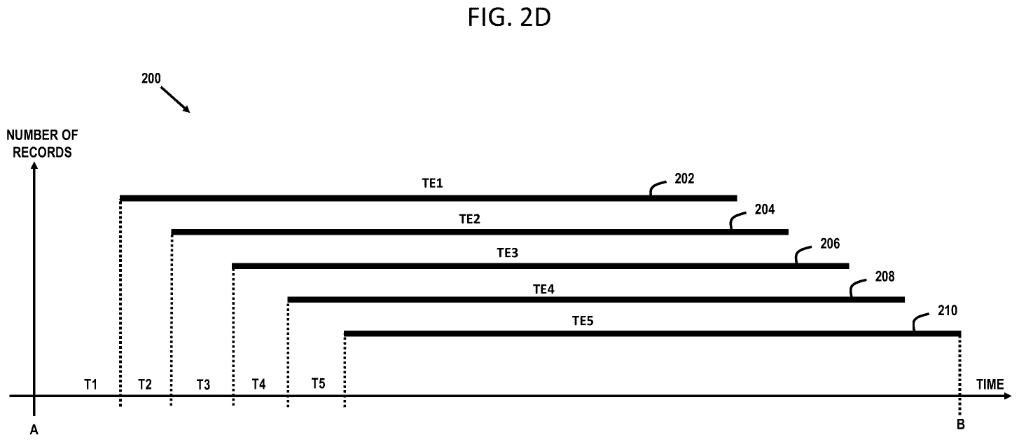

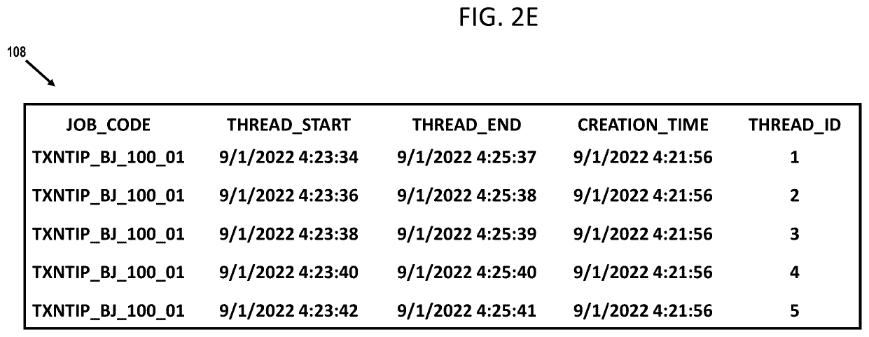

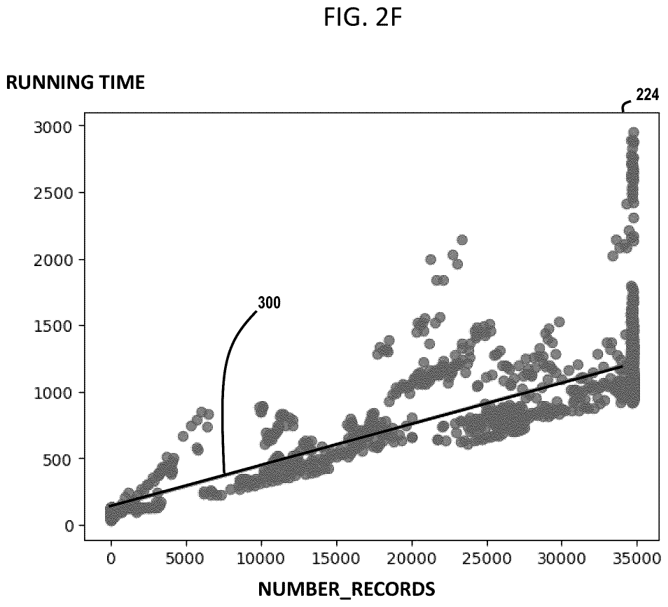

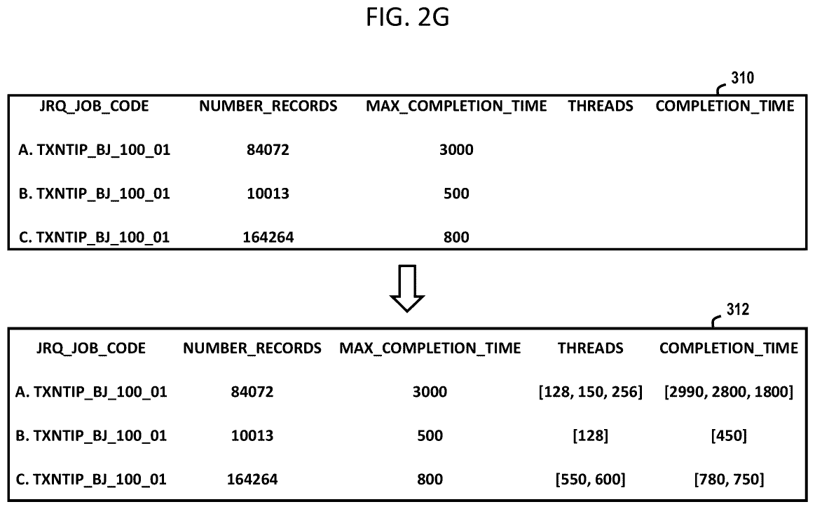

FIG. 2A shows an example of a portion of the training data 108, according to various embodiments.

FIG. 2A shows the training data 108 corresponding to the historical batch job with a code TXNTIP_BJ_100_01, e.g., a historical batch job among a plurality of batch jobs that were previously executed. The batch job with a job code TXNTIP_BJ_100_01 had 147 records processed by 10 threads in 156 seconds. In some embodiments, the total time associated with processing of the historical batch job is considered as maximum completion time of that historical batch job, e.g., 156 seconds in the example of FIG. 2A.

The training data 108 also provides a thread-level information, as shown in a lower portion of FIG. 2A. For example, for each of the threads 1 to 10, the training data 108 provides a number of records and the completion time, e.g., a runtime.

In certain implementations, the training dataset generation subsystem 110 may include a filtering subsystem 120. The filtering subsystem 120 is configured to perform certain processing on the training data 108, for example, filter out historical batch jobs that do not have sufficient correlation between a number of records and a completion time. For example, the historical batch jobs may be considered correlated when, as the number of records increases, the completion time also increases.

In some embodiments, the filtering subsystem 120 may include a job pruning filter 122. The job pruning filter 122 is configured to receive, as an input, the training data 108 corresponding to each historical batch job group containing the historical batch jobs of the same type. The job pruning filter 122 is further configured to determine the correlation coefficient between the running time and the number of records for each batch job type. The job pruning filter 122 is further configured to filter out the historical batch jobs having a correlation coefficient less than a correlation threshold value. In some embodiments, the correlation threshold value is adjustable and may be set, for example, to 0.6.

FIGS. 2B and 2C illustrate distribution of the number of records vs. the running time, for historical batch jobs, according to various embodiments.

Graph 220 of FIG. 2B relates to a historical batch job group of a first type and does not exhibit sufficient correlation. As shown, the completion time of different number of records is approximately the same, i.e., the historical batch jobs of a first type were not processed consistently. Additionally, a portion of data is missing.

Graph 222 of FIG. 2B relates to a historical batch job group of a second type. Similarly to the graph 220, this batch job type does not exhibit sufficient correlation. As shown, the completion time of same number of records varies, i.e., the historical batch jobs of a second type were not processed consistently and, as such, the graph 222 does not exhibit sufficient correlation. Additionally, only a portion of data for a small number of records is present.

Graph 224 of FIG. 2C relates to a historical batch job of a third type. As shown, the completion time increases as a number of records increases, i.e., the historical batch jobs were processed consistently and, as such, the graph 224 exhibits sufficient correlation.

Accordingly, the job pruning filter 122 of the filtering subsystem 120 can identify, within the training data 108, the historical batch job groups that do not show sufficient correlation and the historical batch job groups that show sufficient correlation, by calculating a correlation coefficient for the plurality of historical batch jobs of each batch job type. The job pruning filter 122 can then exclude from further processing the historical batch job or jobs having the correlation coefficient less the correlation threshold value, and pass through, for further processing, the historical batch jobs having the correlation coefficient greater than or equal to the correlation threshold value.

a. Thread Initialization Time and Process Execution Time Calculation

In certain implementations, the resource estimation system 100 may further include a data processor 124. The data processor 124 is configured to receive, as an input, the historical batch jobs passed through by the job pruning filter 122, and perform certain processing related to the historical batch jobs. For example, the data processor 124 may calculate a thread initialization time and/or a process execution time.

The thread initialization time and the process execution time are described below with reference to FIGS. 2D and 2E.

FIG. 2D shows the batch job execution graph according to certain embodiments.

FIG. 2E shows a portion of the training data 108 showing the thread start and end times according to certain embodiments.

In an example of FIG. 2D, the batch job (e.g., a historical batch job) has 5,000 records. As illustrated by a graph 200, the batch job has a first thread 202, a second thread 204, a third thread 206, a fourth thread 208, and a fifth thread 210. The bars of the graph 200 are of an equal length. This illustrates that the records are equally divided between the first to fifth threads 202 to 210. Since the records of the graph 200 are equally divided between the first to fifth threads 202 to 210, the execution time of each of the first to fifth threads 202 to 210 will take approximately the same amount of time.

The batch job starts at point A corresponding to a job start time and ends at point B corresponding to a job completion time.

The time interval between A and B has to be less than or equal to the maximum completion time to satisfy the constraint of the maximum completion time. The time interval from A to B is composed of three parts.

For example, a time period T1 from the time A when the batch job starts to when the first thread 202 is created corresponds to a first part of the time interval from A to B. As shown in the graph 200, each of a time period T2 to start the second thread 204, a time period T3 to start the third thread 206, a time period T4 to start the fourth thread 206, and a time period T5 to start the fifth thread 210 is shorter than the time period T1. A sum of time periods T2 to T5 corresponds to a second part of the time interval from A to B. The time periods T2 to T5 may be equal.

As used herein, a thread initialization time refers to a sum of the first and second parts of the time interval A to B.

A third part of the time interval from A to B corresponds to a process execution time during which the threads are processed. For example, a time period TE5 corresponds to the process execution time.

With reference to FIG. 2E, the training data 108 may contain thread-level data of the historical batch jobs that captured the timing described above with reference to FIG. 2D. For example, for the historical batch job with a code TXNTIP_BJ_100_01, FIG. 2E shows thread-level data of 5 threads, including thread_start time, thread_end time, and creation time.

In an embodiment, the data processor 124 can calculate, for each historical batch job, time_taken_to_start_first_thread and time_taken_to_start_consecutive_threads based on the thread-level data. In an example of FIG. 2E, time_taken_to_start_first_thread is 98 seconds (4:21:56-4:23:34) and time_taken_to_start_consecutive_threads is 2 seconds, e.g., 4:23:36-4:23:34.

The data processor 124 can calculate a thread initialization time according to Equation 1.

$$thread initialization time = [ time\_taken \_to \_start \_first \_thread + time\_taken \_to \_start \_consecutive \_threads * ( TOTAL\_NUMBER \_OF \_THREADS - 1 ) ] \qquad Equation 1$$

In an example of FIG. 2E, the thread initialization time is 98+2 (5−1)=106 seconds.

Since the maximum completion time is provided, the data processor 124 can calculate the process execution time according to Equation 2.

$$Process\_execution \_time = max\_completion \_time - thread initialization time \qquad Equation 2$$

The training dataset generation subsystem 110 may further include a training dataset generator 133. Training dataset generator 133 combines the outputs provided by the filtering subsystem 120 and the data processor 124 to generate one or more training datasets, each corresponding to a certain type of the historical batch job. The training dataset may include data corresponding to the threads, a number of records of the corresponding historical batch job, the thread initialization time, and the process execution times for the threads.

### 2. Model Training

The model training subsystem 114 receives, as an input, an input model 130 of a desired architecture and one or more training datasets. In some implementations, the input model 130 may be a machine learning model.

As used herein, a “machine learning model” or a “model” can refer to a software module configured to be run on one or more processors to provide a classification or numerical value of a property of one or more samples. An example type of model is supervised learning that can be used with embodiments of the present disclosure. Example supervised learning models may include different approaches and algorithms including analytical learning, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ensembles of classifiers, ordinal classification, statistical relational learning, or Proaftn, a multicriteria classification algorithm.

The model may include linear regression, logistic regression, deep recurrent neural network (e.g., long short term memory, LSTM), hidden Markov model (HMM), linear discriminant analysis (LDA), k-means clustering, density-based spatial clustering of applications with noise (DBSCAN), random forest algorithm, support vector machine (SVM), or any model described herein. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

In some embodiments, the machine learning models could include, but not limited to, convolutional neural network (CNN), linear regression, logistic regression, deep recurrent neural network (e.g., fully-connected recurrent neural network (RNN), Gated Recurrent Unit (GRU), long short-term memory, (LSTM)), transformed-based methods (e.g. XLNet, BERT, XLM, ROBERTa), Bayes' classifier, hidden Markov model (HMM), linear discriminant analysis (LDA), k-means clustering, density-based spatial clustering of applications with noise (DBSCAN), random forest algorithm, adaptive boosting (AdaBoost), eXtreme Gradient Boosting (XGBoost), support vector machine (SVM), or a composite model including one or more models proposed above.

In certain implementations, the architecture of the input model 130 may be one of the architectures known to those skilled in the relevant art as being appropriate for the task. For example, the input model 130 may be a regression model that is capable of providing a function that describes the relationship between one or more independent variables and, a response dependent, or target variable.

The model training subsystem 114 performs training on the input model 130 using one or more training datasets to generate one or more ML models 116 each corresponding to a specific type of the batch job.

As a result of the training performed by model training subsystem 114, the generated ML model 116 can be used, given as an input a number of records in the batch job and a maximum completion time, to determine whether it is possible to complete the batch job within the maximum completion time. If the ML model 116 determines that it is possible to complete the batch job within the maximum completion time, then the ML model 116 can determine, e.g., predict or estimate, how many threads are needed to process the records of the batch job within the maximum completion time. The ML model 116 then provides, as an output, a number of threads and a corresponding completion time for a given batch job. The processing performed by the ML model 116 is described in detail below.

FIG. 2F shows an example of a regression model 300 (e.g., a regression graph) for the historical batch job type of FIG. 2C. The regression model 300 may correspond to the ML model 116. Although FIG. 2F illustrates a linear regression, this is not intended to be limiting. In some embodiments, the regression may be non-linear.

For simplicity of explanation, the description of embodiments is provided for generating the ML model 116 for a single type of the batch job. However, additional ML models 116 may be likewise generated for different batch job types.

In certain embodiments, each of the ML models 116 generated by the model training subsystem 114 may be saved in the storage subsystem 106, for example, in association with a job code corresponding to a batch job type. The time_taken_to_start_first_thread and the time_taken_to_start_consecutive_threads may be also stored in association with the ML models 116, respectively.

The model training and deployment is described in a greater detail with reference to FIG. 6.

### 3. Thread Prediction

As described above, the resource estimation system 100 may further include the thread prediction subsystem 103. The thread prediction subsystem 103 may receive, as an input, batch job data including a job code, a number of records, and associated maximum completion time for a batch job, and use a corresponding ML model 116 with associated information to predict the number of threads for processing the batch job within the maximum completion time.

In embodiments, the thread prediction subsystem 103 may, based on the maximum completion time and the number of records, use the thread estimation algorithm to determine (e.g., predict or estimate), a number of threads needed to process the given number of the records of the batch job and the actual completion time that is within the maximum completion time. The thread estimation algorithm may use the ML model 116 corresponding to the job code (e.g., corresponding to a batch job type of the batch job) to predict the number of threads and actual completion time. An example and an explanation of the thread estimation algorithm are provided below.

a. Thread Estimation Algorithm using a Regression Model

```
[ Initialize Variables ]
    List_threads_completiontime = [ ]
    max_thread = maximum allowed threads passed as configuration # e.g., 1000
    total_records = number of records # e.g., 25335
    max_completion_time = maximum time to complete the job # e.g., 1600 sec
[ Algorithm Pseudocode ]
    Iterate no_thread from 2 ... max_thread
          Step-1 : Calculate thread_initialization_time
          Step-2 : process_execution_time = max_completion_time -
    thread_initialization_time
          Step-3 : record_processed_predict = regression_1
    (process_execution_time)
          Step-4 : record processed_expected = total_records / no thread
          Step-5 : If (record_processed_predict >= record_processed_expected)
then
              a) actual_completion_time = regression_2
                (record_processed_expected) + thread_initialization_time
              b) add (no_thread, actual_completion_time) to
                List_threads_completiontime
Return List_threads_completiontime
```

After the variables are initialized, the thread estimation algorithm is executed iteratively for different number of threads, e.g., 2, 3, 4, . . . 10, . . . , 100, . . . , 1000, etc. In a non-limiting example, the number of threads may be a natural number from 2 to a predetermined maximum number, e.g., 1000.

At step 1, for each number of threads, the data processor 124 may use Equation 1 to determine the thread initialization time based on the time_taken_to_start_first_thread and the time_taken_to_start_consecutive_threads that were previously stored for the same job code, e.g., in association with the ML model 116 trained for that job code. However, this is not intended to be limiting. In some embodiments, the batch job data may include thread-based data as described above with reference to FIG. 2E. In such embodiments, the data processor 124 may calculate time taken to_start_first_thread and the time_taken_to_start_consecutive_threads and then calculate the thread initialization time, as described above.

At step 2, the data processor 124 may calculate the process execution time according to Equation 2, by subtracting the thread initialization time from the maximum completion time.

At step 3, the ML model 116 receives, as an input, the process execution time and determines, e.g., provides as an output, a predicted number of records that are predicted to be processed by a current number of threads within the process execution time, e.g., for a current iteration.

At step 4, the thread prediction subsystem 103 can determine an expected number of records that are expected to be processed by a current number of threads, by dividing a total number of records in the batch job by a current number of threads of the current iteration.

At step 5, if the predicted number of records (e.g., obtained as an output of the ML model 116) is greater than or equal to the expected number of records, the thread prediction subsystem 103 provides, as an input, the expected number of records to the ML model 116. The ML model 116 then can output an actual completion time for processing the expected number of records, e.g., in the current iteration. The thread prediction subsystem 103 then saves, in a database 138, the data of the current iteration, e.g., the actual completion time output by the ML model 116, the expected number of records to be processed, the thread initialization time, and a number of threads of the current iteration. However, the described above is not intended to be limiting. For example, the thread prediction subsystem 103 can save the data of the current iteration in the storage subsystem 106.

As a result of a plurality of iterations, the thread prediction subsystem 103 may obtain one or more sets of data items including a number of threads and a corresponding predicted actual completion time.

For example, the thread prediction subsystem 103 saves the data of the iterations in the database 138 in a list 140 of threads and completion times, e.g., in a table, that provides correspondence between the actual completion times and the numbers of threads.

In certain implementations, the list 140 of threads and completion times may be displayed for a user or may be output to an external device.

b. Example of Batch Job Data Processing Using the Thread Prediction Algorithm

FIG. 2G shows examples of possible batch job data for the batch job having a certain job code. The possible batch job data may be referred to as test batch job data, for simplicity of explanation. As illustrated by a reference numeral 310, the batch job of a same type (e.g., having the same job code) may have different batch job data. In an example, the test batch job data has three examples: (A) number of records=84072; maximum completion time=3000 seconds; (B) number of records=10013; maximum completion time=500 seconds; and (C) number of records=164264; maximum completion time=800 seconds.

In FIG. 2G, reference numeral 312 designates an output provided by the thread prediction subsystem 103. For example, for test batch job data (A) having 84072 records, the thread prediction subsystem 103, e.g., the thread estimation algorithm, may output three possible solutions, e.g., combination of a number of threads and completion times: a combination (1) having a first data item corresponding to a number of threads (128) and a second data item corresponding to the completion time (2990 seconds), a combination (2) having a first data item corresponding to a number of threads (150) and a second data item corresponding to the completion time (2800 seconds), and a combination (3) having a first data item corresponding to a number of threads (256) threads and a second data item corresponding to the completion time (1800 seconds). The list 140 of threads and completion times, which is described above, may include one combination, e.g., as for the test batch job data (B), or a plurality of combinations similar to the combinations of the test batch job data (A).

### 4. Thread Estimation Method

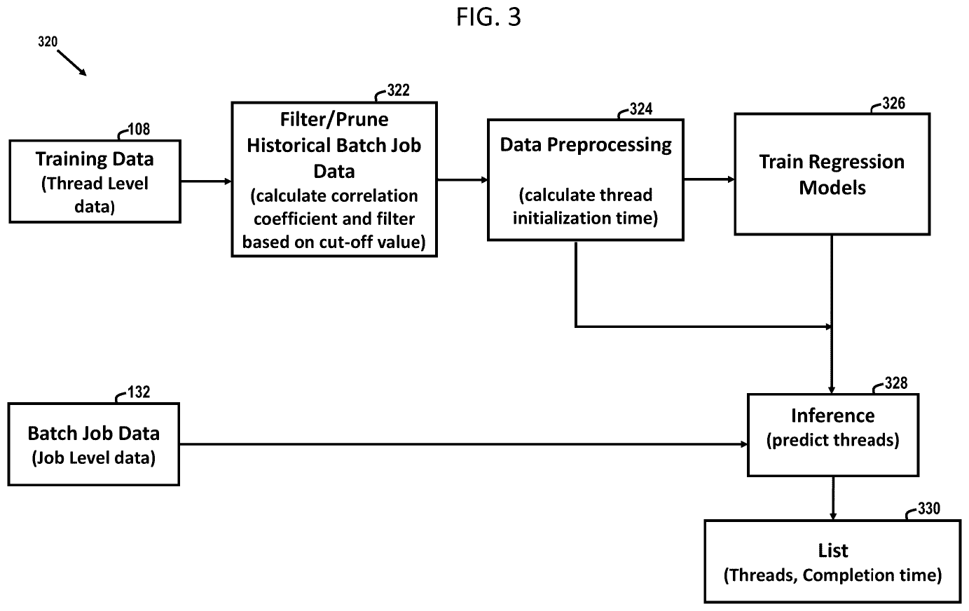

FIG. 3 depicts processing according to various embodiments. For example, the processing 320 depicted in FIG. 3 may be performed by some or all of the training dataset generation subsystem 110, the model training subsystem 114, the data processor 124, and the thread prediction subsystem 103.

The processing 320 depicted in FIG. 3 may be implemented in software (e.g., code, instructions, program) executed by one or more processing units (e.g., processors, cores) of the respective subsystems, using hardware, or combinations thereof. The software may be stored on a non-transitory storage medium (e.g., on a memory device). The method presented in FIG. 3 and described below is intended to be illustrative and non-limiting. Although FIG. 3 depicts the various processing operations occurring in a particular sequence or order, this is not intended to be limiting. In certain alternative embodiments, the processing 320 may be performed in some different order or some operations may be performed at least partially in parallel.

At operation 322, the training dataset generation subsystem 110, e.g., the filtering subsystem 120 or the job pruning filter 122, is configured to receive, as an input, the training data 108 corresponding to the historical batch jobs, and find the correlation coefficient between the running time and the number of records for the batch jobs. The training dataset generation subsystem 110 is configured to filter out the historical batch jobs having a correlation coefficient less than a correlation threshold value, as described above.

At operation 324, the data processor 124 is configured to receive, as an input, the filtered historical batch jobs and calculate a thread initialization time and a process execution time for the historical batch jobs, as described above.

At operation 326, the model training subsystem 114 receives the training dataset(s) output from the training dataset generation subsystem 110. The model training subsystem 114 performs model training using the training datasets and generates the ML models 116, as described in detail above.

At operation 328, the thread prediction subsystem 103 may receive, as an input, batch job data 132 including a number of records of the batch job and associated maximum completion time. The thread prediction subsystem 103 may, based on the maximum completion time and the number of records, determine (e.g., predict or estimate), a number of threads needed to process the records of the batch job and the actual completion time that is within the maximum completion time using the thread estimation algorithm and the ML model 116, as described above.

At operation 330, the thread prediction subsystem 103 may save, in the list 140, records corresponding to the batch job, as described above. Each record may include an entry including the actual completion time in correspondence to the number of threads for the batch job.

### B. Virtual Machine Selection

The output of the thread prediction subsystem 103 is passed to the virtual machine selecting subsystem 104 that performs processing corresponding to the second processing stage. For example, the output of the thread prediction subsystem 103 may include the actual completion time for the given batch job and the number of threads that are saved in the list 140 of threads and completion times. The received information may contain a data string containing a first data item corresponding to a number of threads and a second data item corresponding to the completion time, or a data string containing more than one combination of the first data item and the second data item, e.g., {th1, T1; th2, T2; . . . thn, Tn}. The first data item th1 to thn corresponds to different thread numbers, e.g., 2, 10, . . . , 1000. The second data item T1 to Tn corresponds to completion times corresponding to the thread numbers. The virtual machine selecting subsystem 104 is configured to perform iterative operations for each pair of the first and second data items, to determine an optimal single virtual machine or an optimal virtual machine combination to process the batch job.

In certain embodiments, the virtual machine selecting subsystem 104 includes a virtual machine selector 150. The virtual machine selector 150 is configured to receive, as an input from the thread prediction subsystem 103, data from the list 140 of threads and completion times that includes the number of threads (th) and the actual completion time (T) that were derived for the batch job to be completed within the maximum completion time. The virtual machine selector 150 can calculate a number of cores needed for the batch job, using Equation 3.

$$Number of cores = number of threads / number\_threads \_per \_core , \qquad Equation 3$$

where a number of threads per core may be predetermined and, in some embodiments, may be equal to 2.

Accordingly, if, for example, the virtual machine selector 150 receives a value of 80 as the number of threads (th), the number of cores can be calculated to be equal to 40 (80/2). E.g., a minimum of 40 cores may be required to execute a given batch job within the maximum completion time.

The virtual machine selector 150 also can receive information pertaining to available cloud virtual machines. The information pertaining to available cloud virtual machines may include the geographic region in which a particular virtual machine is located, a usage cost per hour, core configuration (e.g., a number of cores), etc.

In an example, the number of cores may be 18, 32, 64, or 80, where each core configuration may have a different associated cost for the same geographic region or different geographic regions. However, a number of cores is not limiting and may be any appropriate number.

For example, real-time or near real-time information pertaining to the available cloud virtual machines may be saved in the list 109 of cloud virtual machines. In various embodiments, the list 109 of cloud virtual machines may be updated on a periodic basis. In certain implementations, the list 109 of cloud virtual machines may be self-updated using cron-jobs by calling API, e.g., every hour or using any other suitable time period.

The virtual machine selector 150 may determine one or more virtual machines (e.g., a single virtual machine or a virtual machine combination) that have a number of cores equal to or more than 40 cores.

In certain embodiments, the virtual machine selector 150 selects a most efficient single virtual machine in each category, e.g., among the virtual machines having the same number of cores—18, 32, 64, 80. The most optimal single virtual machine may have a lowest associated cost.

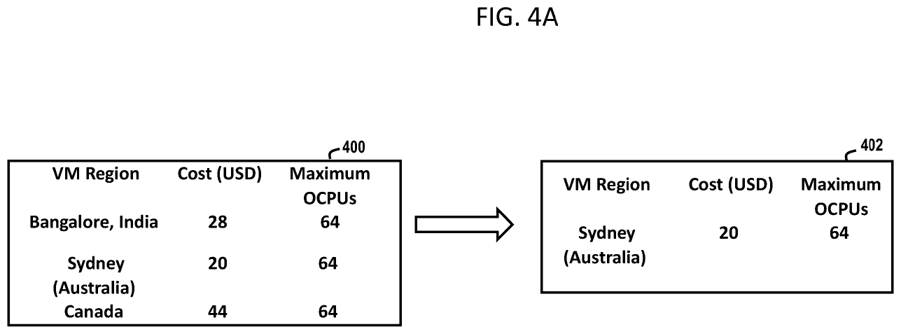

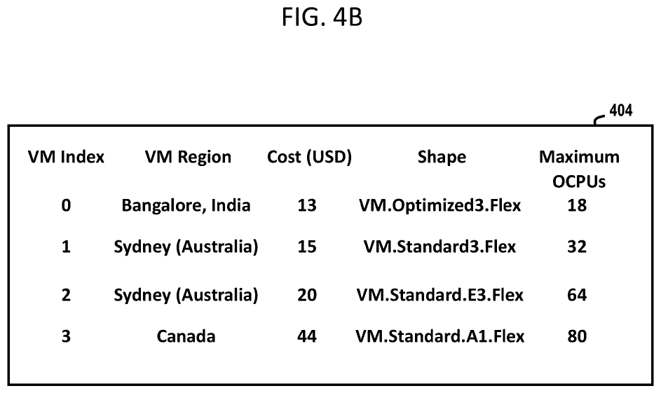

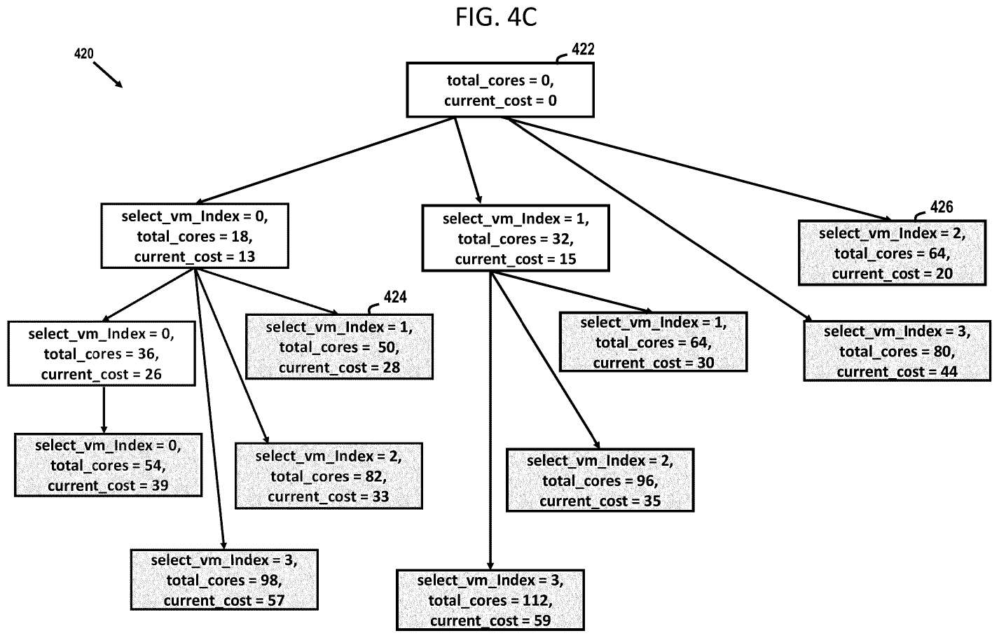

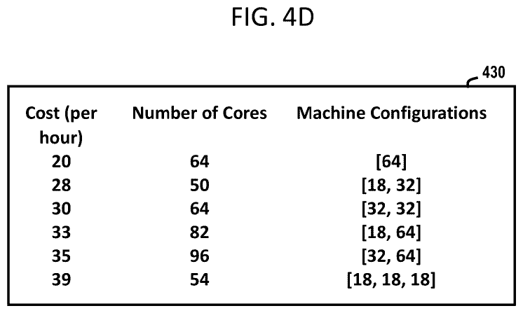

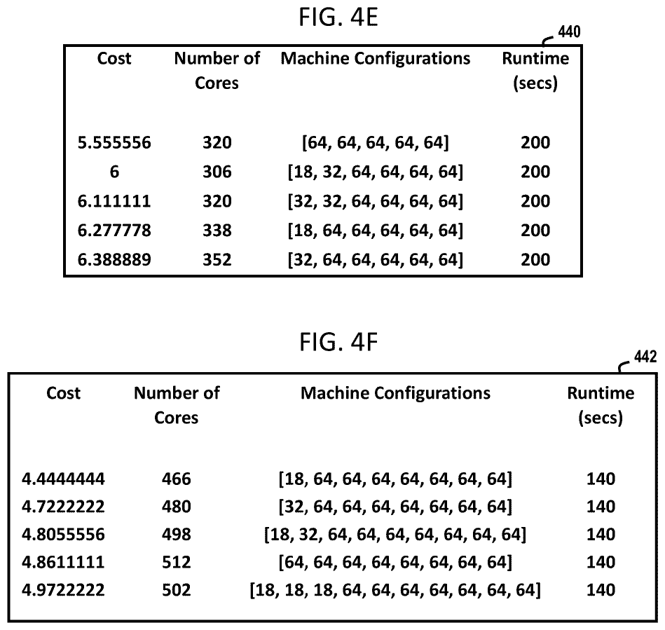

FIGS. 4A to 4F illustrate examples of operations performed by the resource estimation system 100, according to various embodiments.

In some embodiments, the virtual machine selector 150 first sorts the single virtual machines, from the list 109 of cloud virtual machines, by a number of OCPUs. The single virtual machines having the same number of OCPUs may be then grouped in a same group.

FIG. 4A shows an example of a list 400, e.g., a group, containing single virtual machines having the same number of OCPUs, e.g., 64. Likewise, the virtual machine selector 150 may form groups having single virtual machines with 18, 32, and 80 OCPUs. The virtual machine selector 150 then can select a most efficient single virtual machine from each group.

As indicated by a reference numeral 402 in FIG. 4A, the virtual machine selector 150 can select the virtual machine located in Sydney, Australia as the most efficient single virtual machine among the single virtual machines on the list 400. In a non-limiting example, the most efficient single virtual machine is the most economical, e.g., having the lowest cost in the group of single virtual machines having the same number of OCPUs.

FIG. 4B illustrates a list 404 of most efficient virtual machines selected by the virtual machine selector 150 in each category, e.g., most efficient single virtual machines, each having 18, 32, 64, or 80 OCPUs, from all geographic regions from the list 109 of cloud virtual machines.

Optionally, the virtual machine selector 150 can save the list 404 of most efficient single virtual machines.

A virtual machine prediction subsystem 160 is configured to execute the virtual machine prediction algorithm on the most efficient single virtual machines, e.g., from the list 404, to predict the most optimal single virtual machine or the most optimal virtual machine combination to execute the batch job.

```
Virtual machine prediction algorithm
[ Initialize Variables ]
    List_economical_vm = [ ]
    CPU = List of available CPU cores # e.g. [18, 32, 64, 80]
    Cost = List of costs with respect to available CPU cores # e.g. [13, 15, 20, 44]
    List_total_cores = List of possible cores which allows the job to execute in
max_completion_time
[ Algorithm Pseudocode ]
    Iterate total_cores from List_total_cores
          Recursion (current_cores= 0, index = 0, current_cost = 0, current_vm =
    [ ])
          if (current_cores >= total_cores) then
                add [current_cores, current_cost, current_vm] to
          List_economical_vm
          if (current_cores >= total_cores) or (index = length(CPU)) then Return
          recursion (current_cores + = CPU[index], index, current cost + =
    Cost[index], current_vm + [CPU[index]]) # current virtual machine is selected
          recursion(current_cores, index + 1, current_cost, current vm) # current
    virtual machine is not selected
Return List_economical_vm
```

For example, by executing the virtual machine prediction algorithm, the virtual machine prediction subsystem 160 can determine, e.g., predict, the efficient virtual resources to be included in a virtual machine collection. Each of the efficient virtual resources may include a single virtual machine or a virtual machine combination. The efficient virtual resources may be arranged in a list of efficient virtual resources in an order of decreasing efficiency, e.g., in an order of increasing cost, for a given combination of the first data item and the second data item.

The virtual machine prediction algorithm may be iteratively executed for each pair of the number of threads and the completion time, where a result is a prediction of a single virtual machine, a plurality of single virtual machines, a virtual machine combination, and/or a plurality of virtual machine combinations. After each iteration, the virtual machine prediction subsystem 160 may arrange the results of the iteration in a list of efficient virtual resources in an order of increasing cost. For example, the virtual machine prediction subsystem 160 may generate a plurality of lists of efficient virtual resources for a plurality of iterations, e.g., for each pair of the number of threads and the completion time, as shown in FIGS. 4E and 4F and described below. However, if only one execution is performed, the virtual machine prediction subsystem 160 generates one list of efficient virtual resources, as shown in FIG. 4D and described below.

In certain implementations, the list or lists of efficient virtual resources may be displayed on a display or may be output to an external device.

The virtual machine prediction subsystem 160 may select optimal virtual machine(s) 170 (e.g., an optimal single virtual machine or an optimal virtual machine combination) having the lowest cost among the efficient virtual resources from one list of efficient virtual resources or from the plurality of lists of efficient virtual resources.

The batch job, e.g., a real-time batch job, may be executed using the optimal virtual machine(s) 170.

FIG. 4C illustrates the processing 420 performed by the virtual machine prediction subsystem 160 executing the virtual machine prediction algorithm shown above.

Reference number 422 indicates a beginning of the execution of the virtual machine prediction algorithm. As shown, the total cores=0 and the cost=0.

Next, the virtual machines from the list 404 shown in FIG. 4B are recursively selected, where the cores and the costs are added in each iteration. The shaded boxes in FIG. 4C indicate that the combination of the virtual machines yielded a number of cores that is equal to or greater than 40 cores. For example, in a box 424, a number of cores is 50 and a cost is 28. The box 424 illustrates a derived combination including 18-core virtual machine from Bangalore having an index 0 and a 32-core virtual machine from Sydney having an index 1 (refer to FIG. 4B).

As shown in FIG. 4D, the virtual machine prediction subsystem 160 may generate a table 430 of efficient virtual resources using the information of the shaded boxes of FIG. 4C, e.g., using information on the total number of cores greater than 40 and the cost associated with each solution. The virtual machine prediction subsystem 160 may sort the virtual resources based on cost, e.g., to arrange single virtual machines and virtual machine combinations in an ordered sequence of increasing cost. The virtual machine prediction subsystem 160 may include into the ordered sequence a predetermined number of the top most economical virtual machines. The virtual machine prediction subsystem 160 may then select from the ordered sequence the optimal virtual machine or the optimal virtual machine combination that satisfies a number of cores to execute the batch job within the maximum completion time and has the lowest cost.

With continuing reference to FIG. 4D and reference again to FIG. 4B, the virtual machine prediction subsystem 160 can select, from the table 430, the virtual machine of the shape “VM.Standard.E3.flex” located in Sydney and having 64 cores as the optimal virtual machine.

An example described above refers to one iteration, e.g., with regard to one set of a number of threads and a completion time of the batch job. However, the virtual machine selecting subsystem 104 performs similar processing with regard to a plurality of combinations of the numbers of threads and completion times.

In an example described below with reference to FIG. 4E, the thread prediction subsystem 103 provides, as an input to the virtual machine selecting subsystem 104, the list 140 of threads and completion times, {th1=600, t1=200 seconds; th2=900, t2=140 seconds}. The maximum completion time is 210 seconds.

The virtual machine selector 150 can calculate the number of cores required, 300 for the completion time 200 seconds (300/2), and 450 for the completion time 140 seconds (900/2).

FIG. 4E shows a table 440 obtained as a result of the processing performed by the virtual machine selector 150 and the virtual machine prediction subsystem 160 for 300 cores and the completion time 200 seconds.

FIG. 4F shows a table 442 obtained as a result of the processing performed by the virtual machine selector 150 and the virtual machine prediction subsystem 160 for 450 cores and the completion time 140 seconds.

The table 440 and table 442 are respectively generated as a result of iteratively performing the virtual machine prediction algorithm for combinations {th1=600, t1=200; th1=900, t1=140}.

Based on the results obtained in the tables 440 and 442, the virtual machine prediction subsystem 160 may select an optimal virtual machine combination from the table 442, e.g., a single virtual machine having 18 cores of the shape “VM.Optimized.E3.flex” located in Bangalore and seven virtual machines having 64 cores of the shape “VM.Standard.E3.flex” located in Sydney (refer to FIG. 4B).

Accordingly, in the above example, the fastest virtual machine combination is selected that is also is the most economical.

### 1. Virtual Machine(s) Prediction and Selection Method

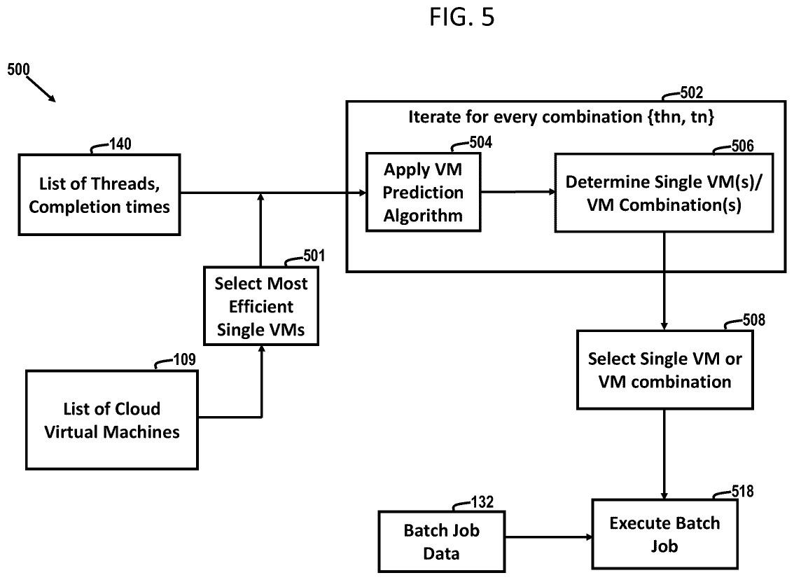

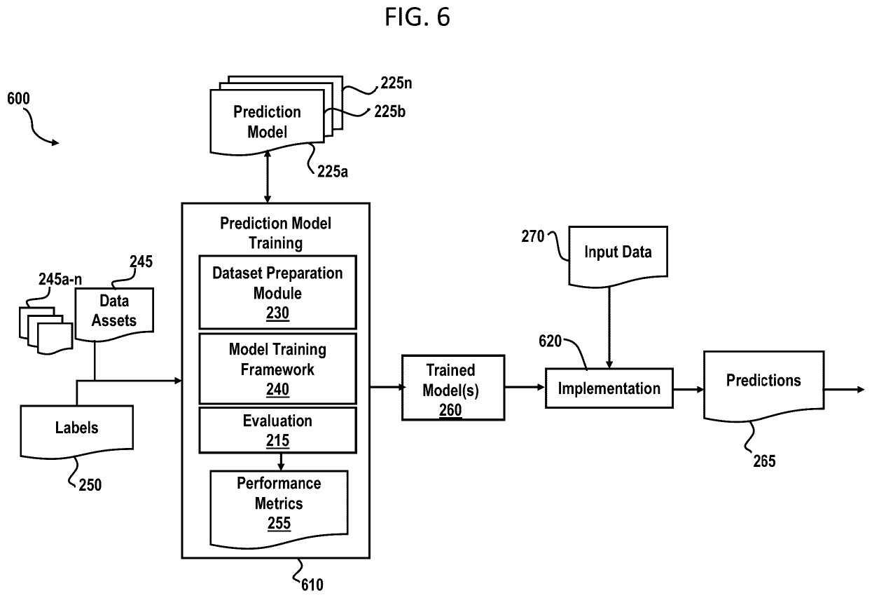

FIG. 5 depicts processing according to various embodiments. For example, at least a part of the processing 500 depicted in FIG. 5 may be performed by the virtual machine selecting subsystem 104.

The processing 500 depicted in FIG. 5 may be implemented in software (e.g., code, instructions, program) executed by one or more processing units (e.g., processors, cores) of the respective subsystems, using hardware, or combinations thereof. The software may be stored on a non-transitory storage medium (e.g., on a memory device). The method presented in FIG. 5 and described below is intended to be illustrative and non-limiting. Although FIG. 5 depicts the various processing operations occurring in a particular sequence or order, this is not intended to be limiting. In certain alternative embodiments, the processing 500 may be performed in some different order or some operations may be performed at least partially in parallel.

At operation 501, the virtual machine selector 150 may receive real-time or near real-time information pertaining to the available cloud virtual machines that may be saved in the list 109 of cloud virtual machines. The virtual machine selector 150 can then perform processing to select most efficient single virtual machines in each category, e.g., most efficient single virtual machines respectively having 18, 32, 64, and 80 OCPUs, described above with reference to FIGS. 4A and 4B.

At operation 502, the virtual machine selecting subsystem 104 may receive information from the model generation subsystem 102, as described above, e.g., a number of threads, completion times. The received information may contain a data string containing a first data item corresponding to a number of threads and a second data item corresponding to the completion time, or a data string containing more than one combination of the first data item and the second data item, e.g., {th1, T1; th2, T2; . . . thn, Tn}. The first data item th1 to thn corresponds to different thread numbers, e.g., 2, 10, . . . , 1000. The second data item T1 to Tn corresponds to completion times corresponding to the thread numbers. The virtual machine selecting subsystem 104 is configured to perform iterative operations for each pair of the first and second data items.

At operation 504, the virtual machine prediction subsystem 160 can execute the virtual machine prediction algorithm on the most efficient single virtual machines.

At operation 506, the virtual machine prediction subsystem 160 can determine, e.g., predict, the efficient virtual resources to be included in a virtual machine collection. The efficient virtual resources may include at least one from among a single virtual machine, a plurality of single virtual machines, a virtual machine combination, and a plurality of virtual machine combinations. The efficient virtual resources may be arranged in a list of efficient virtual resources in an order of the increasing cost, for each combination of the first data item and the second data item, e.g., each pair of the number of threads and the completion time.

The operations 504 and 506 are described in more detail above with reference to FIGS. 4C to 4F.

In embodiments, the operations 504 and 506 may be iteratively executed for each pair of the number of threads and the completion time, where a result is a prediction of a single virtual machine, a plurality of single virtual machines, a virtual machine combination, and/or a plurality of virtual machine combinations. After each iteration, the virtual machine prediction subsystem 160 may arrange the results of the iteration, in a list of efficient virtual resources in an order of increasing cost. For example, the virtual machine prediction subsystem 160 may generate a plurality of lists of efficient virtual resources for a plurality of iterations, as shown in FIGS. 4E and 4F. However, if only one execution of the operations 504 and 506 is performed, the virtual machine prediction subsystem 160 generates one list of efficient virtual resources, as shown in FIG. 4D.

At operation 508, the virtual machine prediction subsystem 160 may select an optimal virtual machine (e.g., a single virtual machine) or an optimal virtual machine combination having the lowest cost among the efficient virtual resources from one list of efficient virtual resources or from the plurality of lists of efficient virtual resources.

At operation 518, the batch job, e.g., a real-time batch job, may be executed using the optimal virtual machine or the optimal virtual machine combination selected in operation 508.

### III. MODEL TRAINING AND DEPLOYMENT

FIG. 6 is a block diagram illustrating a machine-learning system 600 in accordance with various embodiments. For example, the machine-learning system 600 may be a part of the resource estimation system 100 or may be in communication with the resource estimation system 100, to facilitate the training of the models.

As shown in FIG. 6, the machine-learning system 600 includes various stages: a prediction model training stage 610 to build and train models, an evaluation stage 215 to evaluate performance of trained models, and an implementation stage 620 for implementing one or more models. The prediction model training stage 610 builds and trains one or more prediction models 225a and 225b to 225n (‘n’ represents any natural number) to be used by the other stages (which may be referred to herein individually as a prediction model 225 or collectively as the prediction models 225). For example, the prediction models 225 can include any machine learning model described above with respect to the resource estimation system 100.

A prediction model 225 can be a machine-learning model, of a type of the machine-learning models described above. The resource estimation system 100 may employ the same type of prediction model or different types of prediction models for providing predictions to users. Still other types of prediction models may be implemented in other examples according to embodiments.

To train the various prediction models 225, the prediction model training stage 610 may include a dataset preparation module 230, a model training framework 240, and an evaluation stage 215. The dataset preparation module 230 performs the processes of loading data assets 245 (e.g., the training datasets), splitting the data assets 245 into training and validation sets 245a-n so that the system can train and test the prediction models 225, and pre-processing of data assets 245. The splitting the data assets 245 into training and validation sets 245a-n may be performed randomly (e.g., a 60/40%, 70/30%, etc.).

The model training framework 240 performs the processes of determining hyperparameters for the prediction model 225 and performing iterative operations of inputting examples from the training data 245a into the prediction model 225 to find a set of model parameters (e.g., weights and/or biases) that minimizes a cost function(s) such as loss or error function for the prediction model 225. The hyperparameters are settings that can be tuned or optimized to control the behavior of the prediction model 225. Most models explicitly define hyperparameters that control different features of the models such as memory or cost of execution. However, additional hyperparameters may be defined to adapt the prediction model 225 to a specific scenario as, for example, learning rate, number of iterations, regularization weight or strength, and the like.

The cost function can be constructed to measure the difference between the outputs inferred using the prediction models 225 and the ground truth annotated to the samples using the labels. For example, for a supervised learning based model, the goal of the training is to learn a function “h( )” (also sometimes referred to as the hypothesis function) that maps the training input space X to the target value space Y, h: X→Y, such that h (x) is a good predictor for the corresponding value of y. Various different techniques may be used to learn this hypothesis function. In some techniques, as part of deriving the hypothesis function, the cost or loss function may be defined that measures the difference between the ground truth value for an input and the predicted value for that input. As part of training, techniques such as back propagation, random feedback, Direct Feedback Alignment (DFA), Indirect Feedback Alignment (IFA), Hebbian learning, and the like are used to minimize this cost or loss function.

Once the set of model parameters is identified, the model 225 has been trained and the model training framework 240 performs the additional processes of testing or validation using the subset of testing data 245b (testing or validation dataset). The testing or validation processes includes iterative operations of inputting samples from the subset of testing data 245b into the prediction model 225 using a validation technique such as K-Fold Cross-Validation, Leave-one-out Cross-Validation, Leave-one-group-out Cross-Validation, Nested Cross-Validation, or the like to tune the hyperparameters and ultimately find the optimal set of hyperparameters. Once the optimal set of hyperparameters are obtained, a reserved test dataset from the subset of training data 245a may be input into the prediction model 225 to obtain output, and the output is evaluated versus ground truth using correlation techniques such as Bland-Altman method and the Spearman's rank correlation coefficients. Further, performance metrics 255 may be calculated in evaluation stage 215 such as the error, accuracy, precision, recall, receiver operating characteristic curve (ROC), etc. The performance metrics 255 may be used in the evaluation stage 215 to analyze performance of the prediction model 225.

The prediction model training stage 610 outputs trained models including one or more trained models 260. One or more trained models 260 can correspond to one or more ML models 116. The one or more trained models 260 may be deployed and used in the implementation stage 620 for providing predictions 265, as described above. For example, the trained models 260 may receive input data 270 (e.g., a number of records, completion times, etc.) and provide predictions (or outputs) 265 to a user.

### IV. METHODS

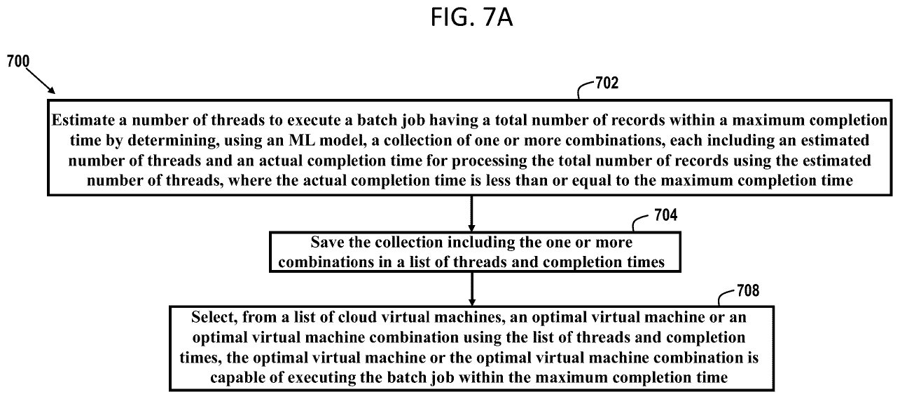

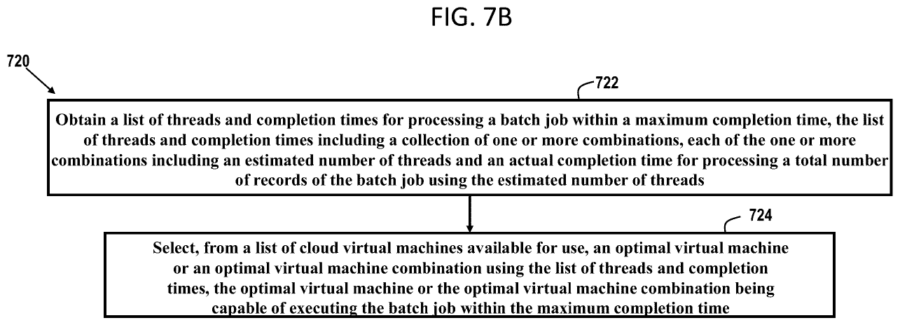

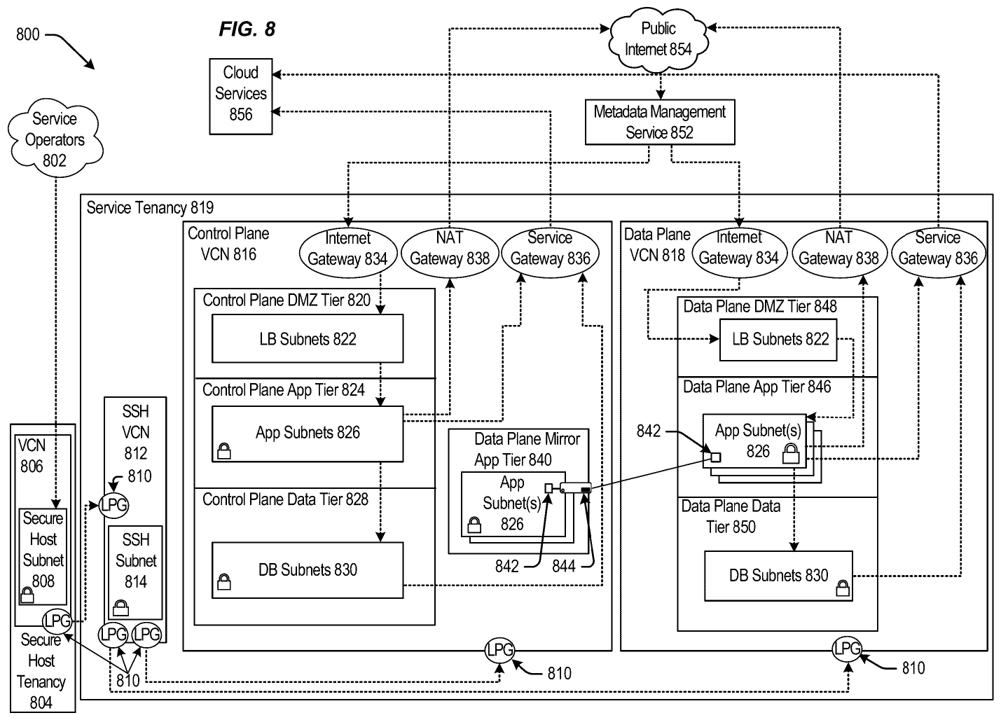

FIG. 7A depicts processing according to various embodiments. For example, the processing 700 depicted in FIG. 7A may be performed by the resource estimation system 100, e.g., by some or all of the model generation subsystem 102, the thread prediction subsystem 103, and the virtual machine selecting subsystem 104.

The processing 700 depicted in FIG. 7A may be implemented in software (e.g., code, instructions, program) executed by one or more processing units (e.g., processors, cores) of the respective subsystems, using hardware, or combinations thereof. The software may be stored on a non-transitory storage medium (e.g., on a memory device). The method presented in FIG. 7A and described below is intended to be illustrative and non-limiting. Although FIG. 7A depicts the various processing operations occurring in a particular sequence or order, this is not intended to be limiting. In certain alternative embodiments, the processing 700 may be performed in some different order or some operations may be performed at least partially in parallel.

With continuing reference to FIG. 7A, at operation 702, the resource estimation system 100 may estimate a number of threads to execute a batch job having a total number of records within a maximum completion time by executing a thread estimation algorithm. For example, the resource estimation system 100 may execute the thread estimation algorithm to determine, using a machine learning (ML) model, a collection of one or more combinations, each including an estimated number of threads and an actual completion time for processing the total number of records using the estimated number of threads, the actual completion time being less than or equal to the maximum completion time.

The resource estimation system 100 may execute a thread estimation algorithm iteratively, for each number of threads among a plurality of numbers of threads between 2 and a predetermined maximum number of threads. For example, the resource estimation system 100 may determine a thread initialization time based on a current number of threads for processing the batch job in a current iteration among a plurality of iterations, determine a process execution time using the maximum completion time and the thread initialization time, provide as an input to the ML model, the process execution time, obtain, as an output of the ML model, a predicted number of records to be processed by the current number of threads in the process execution time, determine whether the predicted number of records is greater than or equal to an expected number of records processable using the current number of threads, and, if the predicted number of records is greater than or equal to the expected number of records, determine, by using the ML model, the actual completion time to process the expected number of records, and save, in the list of threads and completion times, the current number of threads in correspondence to the actual completion time of the batch job, where the current number of threads corresponds to the estimated number of threads of the current iteration.

The resource estimation system 100 may determine, by using the ML model, the actual completion time to process the expected number of records by providing, as an input to the ML model, the expected number of records, where the expected number of records to be processed in the current iteration is calculated by dividing the total number of records by the current number of threads; obtain, as an output of the ML model, a running time corresponding to the expected number of records; and calculate the actual completion time by adding the thread initialization time to the running time output by the ML model.

The resource estimation system 100 then may output the list of threads and completion times based on the plurality of iterations performed for the plurality of numbers of threads.

The resource estimation system 100 may generate a training dataset using the training data related to a historical batch job of a certain type; and train an input model using the training dataset to generate the ML model for processing the batch job of the certain type.

Likewise, the resource estimation system 100 may generate a plurality of training datasets using sets of training data each related to a historical batch job of a certain type among a plurality of batch job types. The resource estimation system 100 may use the plurality of training datasets to train an input model to generate the plurality of ML models, respectively, for processing the batch jobs corresponding to the plurality of batch job types.

The ML model includes a regression model.

At operation 704, the resource estimation system 100 may save the collection including the one or more combinations in a list of threads and completion times.

At operation 708, the resource estimation system 100 may select, from a list of cloud virtual machines available for use in a plurality of geographic regions, an optimal virtual machine or an optimal virtual machine combination using the list of threads and completion times, where the optimal virtual machine or the optimal virtual machine combination is capable of executing the batch job within the maximum completion time.

The resource estimation system 100 may select, from the list of cloud virtual machines, a plurality of most efficient single virtual machines to include a most efficient single virtual machine available for use in each of a plurality of configurations, each of the plurality of configurations corresponding to a number of cores per single virtual machine, and arrange the plurality of most efficient single virtual machines in a list of the plurality of most efficient single virtual machines.

The list of threads and completion times may include a plurality of combinations each including the estimated number of threads and the actual completion time. The resource estimation system 100 may select the optimal virtual machine or the optimal virtual machine combination by performing iterative processing for each combination.

In embodiments, one or more combinations in the list of threads and completion times may include one combination. In this case, the resource estimation system 100 may select the optimal virtual machine or the optimal virtual machine combination by determining a virtual machine collection including a plurality of efficient virtual resources, each of the plurality of efficient virtual resources includes one from among a single virtual machine and a virtual machine combination that are determined from the list of the plurality of most efficient single virtual machines, where each of the plurality of efficient virtual resources has a number of cores greater than or equal to a total number of cores to execute the batch job within the maximum completion time; saving, in a list of efficient virtual resources, the plurality of efficient virtual resources in an order of decreasing efficiency; and selecting the optimal virtual machine or the optimal virtual machine combination as a most efficient virtual resource from the list of efficient virtual resources.

In embodiments, the one or more combinations in the list of threads and completion times may include a plurality of combinations. In this case, the resource estimation system 100 may select the optimal virtual machine or the optimal virtual machine combination by, for each of the plurality of combinations, iteratively performing: (i) determining a virtual machine collection including a plurality of efficient virtual resources, each of the plurality of efficient virtual resources includes one from among a single virtual machine and a virtual machine combination that are determined from the list of the plurality of most efficient single virtual machines, where each of the plurality of efficient virtual resources has a number of cores greater than or equal to a total number of cores to execute the batch job within the maximum completion time; (ii) saving, in a list of efficient virtual resources, the plurality of efficient virtual resources in an order of decreasing efficiency; and (iii) selecting, as the optimal virtual machine or the optimal virtual machine combination, a most efficient virtual resource based on a plurality of lists of efficient virtual resources obtained based on performing a plurality of iterations.

The resource estimation system 100 may select the optimal virtual machine or the optimal virtual machine combination as the most efficient virtual resource by determining a virtual machine or a virtual machine combination having a lowest cost from the list of efficient virtual resources.

FIG. 7B depicts processing according to various embodiments. For example, the processing 720 depicted in FIG. 7B may be performed by the resource estimation system 100, e.g., by some or all of the model generation subsystem 102, the thread prediction subsystem 103, and the virtual machine selecting subsystem 104.

The processing 720 depicted in FIG. 7B may be implemented in software (e.g., code, instructions, program) executed by one or more processing units (e.g., processors, cores) of the respective subsystems, using hardware, or combinations thereof. The software may be stored on a non-transitory storage medium (e.g., on a memory device). The method presented in FIG. 7B and described below is intended to be illustrative and non-limiting. Although FIG. 7B depicts the various processing operations occurring in a particular sequence or order, this is not intended to be limiting. In certain alternative embodiments, the processing 720 may be performed in some different order or some operations may be performed at least partially in parallel.

With continuing reference to FIG. 7B, at operation 722, the resource estimation system 100 may obtain a list of threads and completion times for processing a batch job within a maximum completion time, the list of threads and completion times including a collection of one or more combinations, each of the one or more combinations including an estimated number of threads and an actual completion time for processing a total number of records of the batch job using the estimated number of threads.

At operation 724, the resource estimation system 100 may select, from a list of cloud virtual machines available for use, an optimal virtual machine or an optimal virtual machine combination using the list of threads and completion times, the optimal virtual machine or the optimal virtual machine combination being capable of executing the batch job within the maximum completion time.

### Example Cloud Implementation

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each virtual machine, deploy middleware such as databases, create storage buckets for workloads and backups, and even install enterprise software into that virtual machine. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 8 is a block diagram 800 illustrating an example pattern of an IaaS architecture, according to at least one embodiment. Service operators 802 can be communicatively coupled to a secure host tenancy 804 that can include a virtual cloud network (VCN) 806 and a secure host subnet 808. In some examples, the service operators 802 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 806 and/or the Internet.

The VCN 806 can include a local peering gateway (LPG) 810 that can be communicatively coupled to a secure shell (SSH) VCN 812 via an LPG 810 contained in the SSH VCN 812. The SSH VCN 812 can include an SSH subnet 814, and the SSH VCN 812 can be communicatively coupled to a control plane VCN 816 via the LPG 810 contained in the control plane VCN 816. Also, the SSH VCN 812 can be communicatively coupled to a data plane VCN 818 via an LPG 810. The control plane VCN 816 and the data plane VCN 818 can be contained in a service tenancy 819 that can be owned and/or operated by the IaaS provider.

The control plane VCN 816 can include a control plane demilitarized zone (DMZ) tier 820 that acts as a perimeter network (e.g., portions of a corporate network between the corporate intranet and external networks). The DMZ-based servers may have restricted responsibilities and help keep breaches contained. Additionally, the DMZ tier 820 can include one or more load balancer (LB) subnet(s) 822, a control plane app tier 824 that can include app subnet(s) 826, a control plane data tier 828 that can include database (DB) subnet(s) 830 (e.g., frontend DB subnet(s) and/or backend DB subnet(s)). The LB subnet(s) 822 contained in the control plane DMZ tier 820 can be communicatively coupled to the app subnet(s) 826 contained in the control plane app tier 824 and an Internet gateway 834 that can be contained in the control plane VCN 816, and the app subnet(s) 826 can be communicatively coupled to the DB subnet(s) 830 contained in the control plane data tier 828 and a service gateway 836 and a network address translation (NAT) gateway 838. The control plane VCN 816 can include the service gateway 836 and the NAT gateway 838.

The control plane VCN 816 can include a data plane mirror app tier 840 that can include app subnet(s) 826. The app subnet(s) 826 contained in the data plane mirror app tier 840 can include a virtual network interface controller (VNIC) 842 that can execute a compute instance 844. The compute instance 844 can communicatively couple the app subnet(s) 826 of the data plane mirror app tier 840 to app subnet(s) 826 that can be contained in a data plane app tier 846.

The data plane VCN 818 can include the data plane app tier 846, a data plane DMZ tier 848, and a data plane data tier 850. The data plane DMZ tier 848 can include LB subnet(s) 822 that can be communicatively coupled to the app subnet(s) 826 of the data plane app tier 846 and the Internet gateway 834 of the data plane VCN 818. The app subnet(s) 826 can be communicatively coupled to the service gateway 836 of the data plane VCN 818 and the NAT gateway 838 of the data plane VCN 818. The data plane data tier 850 can also include the DB subnet(s) 830 that can be communicatively coupled to the app subnet(s) 826 of the data plane app tier 846.

The Internet gateway 834 of the control plane VCN 816 and of the data plane VCN 818 can be communicatively coupled to a metadata management service 852 that can be communicatively coupled to public Internet 854. Public Internet 854 can be communicatively coupled to the NAT gateway 838 of the control plane VCN 816 and of the data plane VCN 818. The service gateway 836 of the control plane VCN 816 and of the data plane VCN 818 can be communicatively couple to cloud services 856.

In some examples, the service gateway 836 of the control plane VCN 816 or of the data plane VCN 818 can make application programming interface (API) calls to cloud services 856 without going through public Internet 854. The API calls to cloud services 856 from the service gateway 836 can be one-way: the service gateway 836 can make API calls to cloud services 856, and cloud services 856 can send requested data to the service gateway 836. But, cloud services 856 may not initiate API calls to the service gateway 836.

In some examples, the secure host tenancy 804 can be directly connected to the service tenancy 819, which may be otherwise isolated. The secure host subnet 808 can communicate with the SSH subnet 814 through an LPG 810 that may enable two-way communication over an otherwise isolated system. Connecting the secure host subnet 808 to the SSH subnet 814 may give the secure host subnet 808 access to other entities within the service tenancy 819.

The control plane VCN 816 may allow users of the service tenancy 819 to set up or otherwise provision desired resources. Desired resources provisioned in the control plane VCN 816 may be deployed or otherwise used in the data plane VCN 818. In some examples, the control plane VCN 816 can be isolated from the data plane VCN 818, and the data plane mirror app tier 840 of the control plane VCN 816 can communicate with the data plane app tier 846 of the data plane VCN 818 via VNICs 842 that can be contained in the data plane mirror app tier 840 and the data plane app tier 846.

In some examples, users of the system, or customers, can make requests, for example create, read, update, or delete (CRUD) operations, through public Internet 854 that can communicate the requests to the metadata management service 852. The metadata management service 852 can communicate the request to the control plane VCN 816 through the Internet gateway 834. The request can be received by the LB subnet(s) 822 contained in the control plane DMZ tier 820. The LB subnet(s) 822 may determine that the request is valid, and in response to this determination, the LB subnet(s) 822 can transmit the request to app subnet(s) 826 contained in the control plane app tier 824. If the request is validated and requires a call to public Internet 854, the call to public Internet 854 may be transmitted to the NAT gateway 838 that can make the call to public Internet 854. Metadata that may be desired to be stored by the request can be stored in the DB subnet(s) 830.

In some examples, the data plane mirror app tier 840 can facilitate direct communication between the control plane VCN 816 and the data plane VCN 818. For example, changes, updates, or other suitable modifications to configuration may be desired to be applied to the resources contained in the data plane VCN 818. Via a VNIC 842, the control plane VCN 816 can directly communicate with, and can thereby execute the changes, updates, or other suitable modifications to configuration to, resources contained in the data plane VCN 818.

In some embodiments, the control plane VCN 816 and the data plane VCN 818 can be contained in the service tenancy 819. In this case, the user, or the customer, of the system may not own or operate either the control plane VCN 816 or the data plane VCN 818. Instead, the IaaS provider may own or operate the control plane VCN 816 and the data plane VCN 818, both of which may be contained in the service tenancy 819. This embodiment can enable isolation of networks that may prevent users or customers from interacting with other users', or other customers', resources. Also, this embodiment may allow users or customers of the system to store databases privately without needing to rely on public Internet 854, which may not have a desired level of threat prevention, for storage.

In other embodiments, the LB subnet(s) 822 contained in the control plane VCN 816 can be configured to receive a signal from the service gateway 836. In this embodiment, the control plane VCN 816 and the data plane VCN 818 may be configured to be called by a customer of the IaaS provider without calling public Internet 854. Customers of the IaaS provider may desire this embodiment since database(s) that the customers use may be controlled by the IaaS provider and may be stored on the service tenancy 819, which may be isolated from public Internet 854.

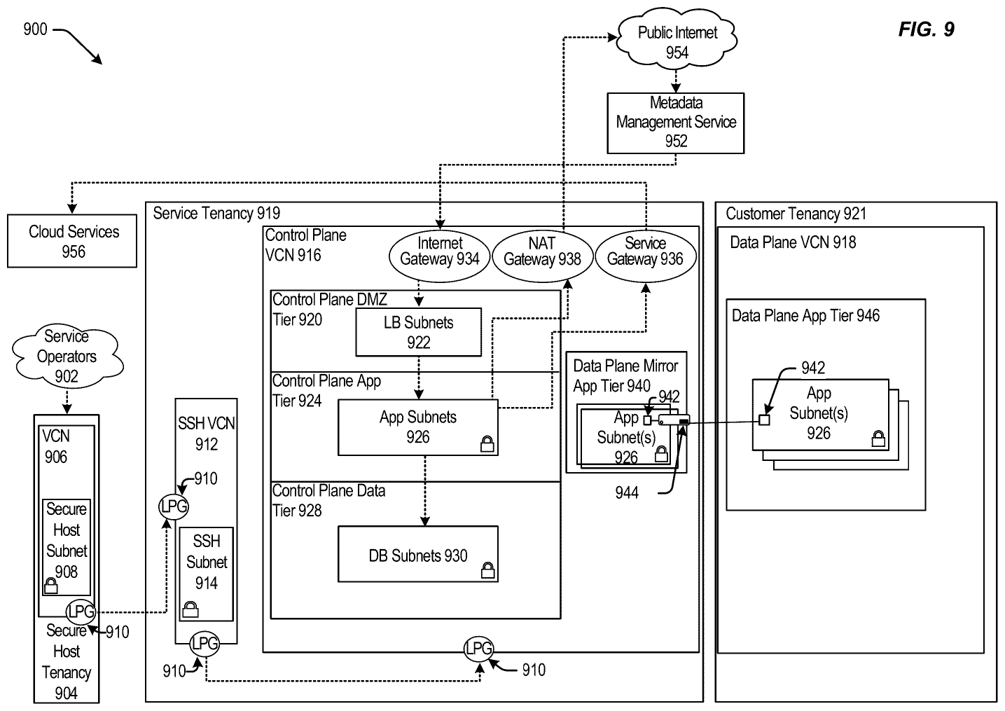

FIG. 9 is a block diagram 900 illustrating another example pattern of an IaaS architecture, according to at least one embodiment. Service operators 902 (e.g., service operators 802 of FIG. 8) can be communicatively coupled to a secure host tenancy 904 (e.g., the secure host tenancy 804 of FIG. 8) that can include a virtual cloud network (VCN) 906 (e.g., the VCN 806 of FIG. 8) and a secure host subnet 908 (e.g., the secure host subnet 808 of FIG. 8). The VCN 906 can include a local peering gateway (LPG) 910 (e.g., the LPG 810 of FIG. 8) that can be communicatively coupled to a secure shell (SSH) VCN 912 (e.g., the SSH VCN 812 of FIG. 8) via an LPG 810 contained in the SSH VCN 912. The SSH VCN 912 can include an SSH subnet 914 (e.g., the SSH subnet 814 of FIG. 8), and the SSH VCN 912 can be communicatively coupled to a control plane VCN 916 (e.g., the control plane VCN 816 of FIG. 8) via an LPG 910 contained in the control plane VCN 916. The control plane VCN 916 can be contained in a service tenancy 919 (e.g., the service tenancy 819 of FIG. 8), and the data plane VCN 918 (e.g., the data plane VCN 818 of FIG. 8) can be contained in a customer tenancy 921 that may be owned or operated by users, or customers, of the system.

The control plane VCN 916 can include a control plane DMZ tier 920 (e.g., the control plane DMZ tier 820 of FIG. 8) that can include LB subnet(s) 922 (e.g., LB subnet(s) 822 of FIG. 8), a control plane app tier 924 (e.g., the control plane app tier 824 of FIG. 8) that can include app subnet(s) 926 (e.g., app subnet(s) 826 of FIG. 8), a control plane data tier 928 (e.g., the control plane data tier 828 of FIG. 8) that can include database (DB) subnet(s) 930 (e.g., similar to DB subnet(s) 830 of FIG. 8). The LB subnet(s) 922 contained in the control plane DMZ tier 920 can be communicatively coupled to the app subnet(s) 926 contained in the control plane app tier 924 and an Internet gateway 934 (e.g., the Internet gateway 834 of FIG. 8) that can be contained in the control plane VCN 916, and the app subnet(s) 926 can be communicatively coupled to the DB subnet(s) 930 contained in the control plane data tier 928 and a service gateway 936 (e.g., the service gateway 836 of FIG. 8) and a network address translation (NAT) gateway 938 (e.g., the NAT gateway 838 of FIG. 8). The control plane VCN 916 can include the service gateway 936 and the NAT gateway 938.

The control plane VCN 916 can include a data plane mirror app tier 940 (e.g., the data plane mirror app tier 840 of FIG. 8) that can include app subnet(s) 926. The app subnet(s) 926 contained in the data plane mirror app tier 940 can include a virtual network interface controller (VNIC) 942 (e.g., the VNIC of 842) that can execute a compute instance 944 (e.g., similar to the compute instance 844 of FIG. 8). The compute instance 944 can facilitate communication between the app subnet(s) 926 of the data plane mirror app tier 940 and the app subnet(s) 926 that can be contained in a data plane app tier 946 (e.g., the data plane app tier 846 of FIG. 8) via the VNIC 942 contained in the data plane mirror app tier 940 and the VNIC 942 contained in the data plane app tier 946.

The Internet gateway 934 contained in the control plane VCN 916 can be communicatively coupled to a metadata management service 952 (e.g., the metadata management service 852 of FIG. 8) that can be communicatively coupled to public Internet 954 (e.g., public Internet 854 of FIG. 8). Public Internet 954 can be communicatively coupled to the NAT gateway 938 contained in the control plane VCN 916. The service gateway 936 contained in the control plane VCN 916 can be communicatively couple to cloud services 956 (e.g., cloud services 856 of FIG. 8).

In some examples, the data plane VCN 918 can be contained in the customer tenancy 921. In this case, the IaaS provider may provide the control plane VCN 916 for each customer, and the IaaS provider may, for each customer, set up a unique compute instance 944 that is contained in the service tenancy 919. Each compute instance 944 may allow communication between the control plane VCN 916, contained in the service tenancy 919, and the data plane VCN 918 that is contained in the customer tenancy 921. The compute instance 944 may allow resources, that are provisioned in the control plane VCN 916 that is contained in the service tenancy 919, to be deployed or otherwise used in the data plane VCN 918 that is contained in the customer tenancy 921.

In other examples, the customer of the IaaS provider may have databases that live in the customer tenancy 921. In this example, the control plane VCN 916 can include the data plane mirror app tier 940 that can include app subnet(s) 926. The data plane mirror app tier 940 can reside in the data plane VCN 918, but the data plane mirror app tier 940 may not live in the data plane VCN 918. That is, the data plane mirror app tier 940 may have access to the customer tenancy 921, but the data plane mirror app tier 940 may not exist in the data plane VCN 918 or be owned or operated by the customer of the IaaS provider. The data plane mirror app tier 940 may be configured to make calls to the data plane VCN 918 but may not be configured to make calls to any entity contained in the control plane VCN 916. The customer may desire to deploy or otherwise use resources in the data plane VCN 918 that are provisioned in the control plane VCN 916, and the data plane mirror app tier 940 can facilitate the desired deployment, or other usage of resources, of the customer.

In some embodiments, the customer of the IaaS provider can apply filters to the data plane VCN 918. In this embodiment, the customer can determine what the data plane VCN 918 can access, and the customer may restrict access to public Internet 954 from the data plane VCN 918. The IaaS provider may not be able to apply filters or otherwise control access of the data plane VCN 918 to any outside networks or databases. Applying filters and controls by the customer onto the data plane VCN 918, contained in the customer tenancy 921, can help isolate the data plane VCN 918 from other customers and from public Internet 954.

In some embodiments, cloud services 956 can be called by the service gateway 936 to access services that may not exist on public Internet 954, on the control plane VCN 916, or on the data plane VCN 918. The connection between cloud services 956 and the control plane VCN 916 or the data plane VCN 918 may not be live or continuous. Cloud services 956 may exist on a different network owned or operated by the IaaS provider. Cloud services 956 may be configured to receive calls from the service gateway 936 and may be configured to not receive calls from public Internet 954. Some cloud services 956 may be isolated from other cloud services 956, and the control plane VCN 916 may be isolated from cloud services 956 that may not be in the same region as the control plane VCN 916. For example, the control plane VCN 916 may be located in “Region 1,” and cloud service “Deployment 8,” may be located in Region 1 and in “Region 2.” If a call to Deployment 8 is made by the service gateway 936 contained in the control plane VCN 916 located in Region 1, the call may be transmitted to Deployment 8 in Region 1. In this example, the control plane VCN 916, or Deployment 8 in Region 1, may not be communicatively coupled to, or otherwise in communication with, Deployment 8 in Region 2.

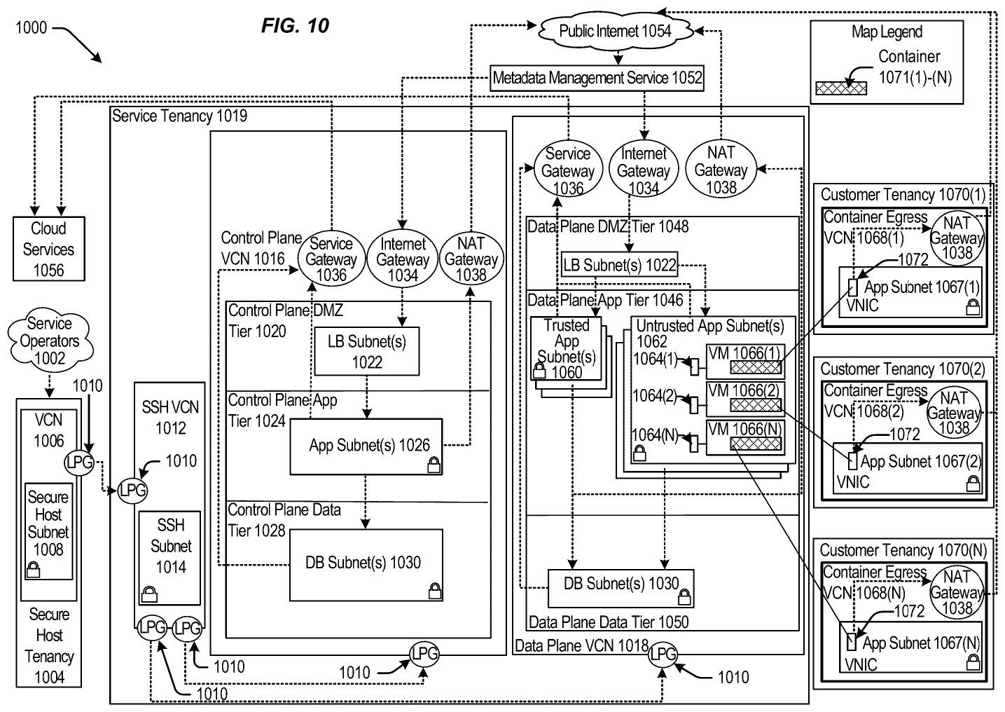

FIG. 10 is a block diagram 1000 illustrating another example pattern of an IaaS architecture, according to at least one embodiment. Service operators 1002 (e.g., service operators 802 of FIG. 8) can be communicatively coupled to a secure host tenancy 1004 (e.g., the secure host tenancy 804 of FIG. 8) that can include a virtual cloud network (VCN) 1006 (e.g., the VCN 806 of FIG. 8) and a secure host subnet 1008 (e.g., the secure host subnet 808 of FIG. 8). The VCN 1006 can include an LPG 1010 (e.g., the LPG 810 of FIG. 8) that can be communicatively coupled to an SSH VCN 1012 (e.g., the SSH VCN 812 of FIG. 8) via an LPG 1010 contained in the SSH VCN 1012. The SSH VCN 1012 can include an SSH subnet 1014 (e.g., the SSH subnet 814 of FIG. 8), and the SSH VCN 1012 can be communicatively coupled to a control plane VCN 1016 (e.g., the control plane VCN 816 of FIG. 8) via an LPG 1010 contained in the control plane VCN 1016 and to a data plane VCN 1018 (e.g., the data plane 818 of FIG. 8) via an LPG 1010 contained in the data plane VCN 1018. The control plane VCN 1016 and the data plane VCN 1018 can be contained in a service tenancy 1019 (e.g., the service tenancy 819 of FIG. 8).

The control plane VCN 1016 can include a control plane DMZ tier 1020 (e.g., the control plane DMZ tier 820 of FIG. 8) that can include load balancer (LB) subnet(s) 1022 (e.g., LB subnet(s) 822 of FIG. 8), a control plane app tier 1024 (e.g., the control plane app tier 824 of FIG. 8) that can include app subnet(s) 1026 (e.g., similar to app subnet(s) 826 of FIG. 8), a control plane data tier 1028 (e.g., the control plane data tier 828 of FIG. 8) that can include DB subnet(s) 1030. The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 834 of FIG. 8) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 8) and a network address translation (NAT) gateway 1038 (e.g., the NAT gateway 838 of FIG. 8). The control plane VCN 1016 can include the service gateway 1036 and the NAT gateway 1038.

The data plane VCN 1018 can include a data plane app tier 1046 (e.g., the data plane app tier 846 of FIG. 8), a data plane DMZ tier 1048 (e.g., the data plane DMZ tier 848 of FIG. 8), and a data plane data tier 1050 (e.g., the data plane data tier 850 of FIG. 8). The data plane DMZ tier 1048 can include LB subnet(s) 1022 that can be communicatively coupled to trusted app subnet(s) 1060 and untrusted app subnet(s) 1062 of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include one or more primary VNICs 1064(1)-(N) that can be communicatively coupled to tenant virtual machines (VMs) 1066(1)-(N). Each tenant virtual machine 1066(1)-(N) can be communicatively coupled to a respective app subnet 1067(1)-(N) that can be contained in respective container egress VCNs 1068(1)-(N) that can be contained in respective customer tenancies 1070(1)-(N). Respective secondary VNICs 1072(1)-(N) can facilitate communication between the untrusted app subnet(s) 1062 contained in the data plane VCN 1018 and the app subnet contained in the container egress VCNs 1068(1)-(N). Each container egress VCNs 1068(1)-(N) can include a NAT gateway 1038 that can be communicatively coupled to public Internet 1054 (e.g., public Internet 854 of FIG. 8).

The Internet gateway 1034 contained in the control plane VCN 1016 and contained in the data plane VCN 1018 can be communicatively coupled to a metadata management service 1052 (e.g., the metadata management service 852 of FIG. 8) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively couple to cloud services 1056.

In some embodiments, the data plane VCN 1018 can be integrated with customer tenancies 1070. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1046. Code to run the function may be executed in the virtual machines 1066(1)-(N), and the code may not be configured to run anywhere else on the data plane VCN 1018. Each virtual machine 1066(1)-(N) may be connected to one customer tenancy 1070. Respective containers 1071(1)-(N) contained in the virtual machines 1066(1)-(N) may be configured to run the code. In this case, there can be a dual isolation (e.g., the containers 1071(1)-(N) running code, where the containers 1071(1)-(N) may be contained in at least the virtual machine 1066(1)-(N) that are contained in the untrusted app subnet(s) 1062), which may help prevent incorrect or otherwise undesirable code from damaging the network of the IaaS provider or from damaging a network of a different customer. The containers 1071(1)-(N) may be communicatively coupled to the customer tenancy 1070 and may be configured to transmit or receive data from the customer tenancy 1070. The containers 1071(1)-(N) may not be configured to transmit or receive data from any other entity in the data plane VCN 1018. Upon completion of running the code, the IaaS provider may kill or otherwise dispose of the containers 1071(1)-(N).

In some embodiments, the trusted app subnet(s) 1060 may run code that may be owned or operated by the IaaS provider. In this embodiment, the trusted app subnet(s) 1060 may be communicatively coupled to the DB subnet(s) 1030 and be configured to execute CRUD operations in the DB subnet(s) 1030. The untrusted app subnet(s) 1062 may be communicatively coupled to the DB subnet(s) 1030, but in this embodiment, the untrusted app subnet(s) may be configured to execute read operations in the DB subnet(s) 1030. The containers 1071(1)-(N) that can be contained in the virtual machine 1066(1)-(N) of each customer and that may run code from the customer may not be communicatively coupled with the DB subnet(s) 1030.

In other embodiments, the control plane VCN 1016 and the data plane VCN 1018 may not be directly communicatively coupled. In this embodiment, there may be no direct communication between the control plane VCN 1016 and the data plane VCN 1018. However, communication can occur indirectly through at least one method. An LPG 1010 may be established by the IaaS provider that can facilitate communication between the control plane VCN 1016 and the data plane VCN 1018. In another example, the control plane VCN 1016 or the data plane VCN 1018 can make a call to cloud services 1056 via the service gateway 1036. For example, a call to cloud services 1056 from the control plane VCN 1016 can include a request for a service that can communicate with the data plane VCN 1018.

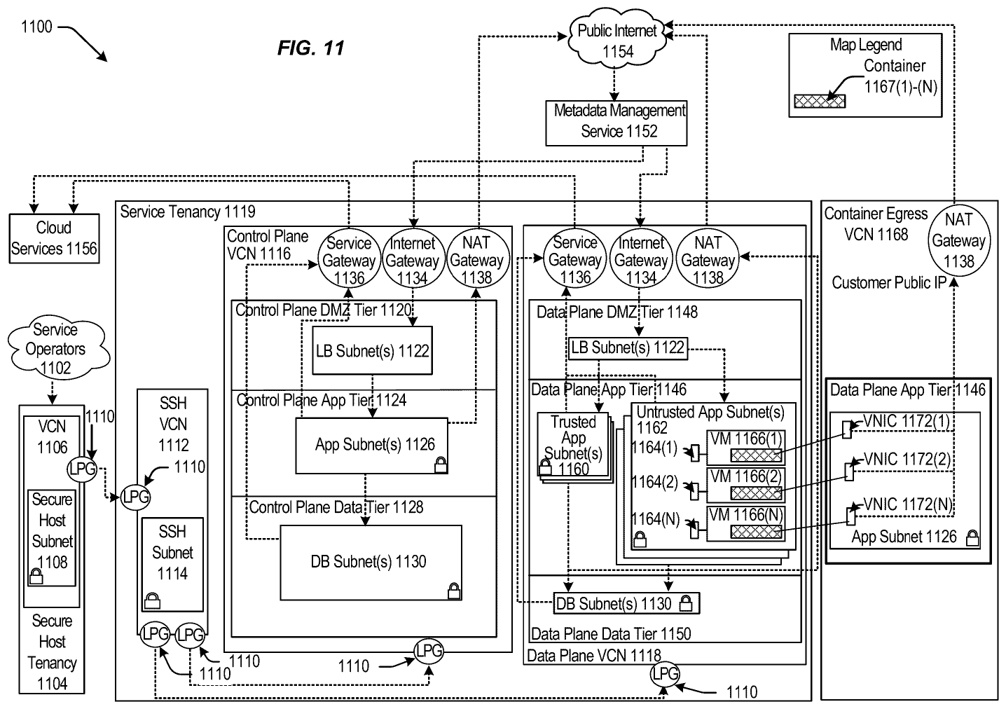

FIG. 11 is a block diagram 1100 illustrating another example pattern of an IaaS architecture, according to at least one embodiment. Service operators 1102 (e.g., service operators 802 of FIG. 8) can be communicatively coupled to a secure host tenancy 1104 (e.g., the secure host tenancy 804 of FIG. 8) that can include a virtual cloud network (VCN) 1106 (e.g., the VCN 806 of FIG. 8) and a secure host subnet 1108 (e.g., the secure host subnet 808 of FIG. 8). The VCN 1106 can include an LPG 1110 (e.g., the LPG 810 of FIG. 8) that can be communicatively coupled to an SSH VCN 1112 (e.g., the SSH VCN 812 of FIG. 8) via an LPG 1110 contained in the SSH VCN 1112. The SSH VCN 1112 can include an SSH subnet 1114 (e.g., the SSH subnet 814 of FIG. 8), and the SSH VCN 1112 can be communicatively coupled to a control plane VCN 1116 (e.g., the control plane VCN 816 of FIG. 8) via an LPG 1110 contained in the control plane VCN 1116 and to a data plane VCN 1118 (e.g., the data plane 818 of FIG. 8) via an LPG 1110 contained in the data plane VCN 1118. The control plane VCN 1116 and the data plane VCN 1118 can be contained in a service tenancy 1119 (e.g., the service tenancy 819 of FIG. 8).

The control plane VCN 1116 can include a control plane DMZ tier 1120 (e.g., the control plane DMZ tier 820 of FIG. 8) that can include LB subnet(s) 1122 (e.g., LB subnet(s) 822 of FIG. 8), a control plane app tier 1124 (e.g., the control plane app tier 824 of FIG. 8) that can include app subnet(s) 1126 (e.g., app subnet(s) 826 of FIG. 8), a control plane data tier 1128 (e.g., the control plane data tier 828 of FIG. 8) that can include DB subnet(s) 1130 (e.g., DB subnet(s) 1030 of FIG. 10). The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 834 of FIG. 8) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 8) and a network address translation (NAT) gateway 1138 (e.g., the NAT gateway 838 of FIG. 8). The control plane VCN 1116 can include the service gateway 1136 and the NAT gateway 1138.

The data plane VCN 1118 can include a data plane app tier 1146 (e.g., the data plane app tier 846 of FIG. 8), a data plane DMZ tier 1148 (e.g., the data plane DMZ tier 848 of FIG. 8), and a data plane data tier 1150 (e.g., the data plane data tier 850 of FIG. 8). The data plane DMZ tier 1148 can include LB subnet(s) 1122 that can be communicatively coupled to trusted app subnet(s) 1160 (e.g., trusted app subnet(s) 1060 of FIG. 10) and untrusted app subnet(s) 1162 (e.g., untrusted app subnet(s) 1062 of FIG. 10) of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include primary VNICs 1164(1)-(N) that can be communicatively coupled to tenant virtual machines (VMs) 1166(1)-(N) residing within the untrusted app subnet(s) 1162. Each tenant virtual machine 1166(1)-(N) can run code in a respective container 1167(1)-(N), and be communicatively coupled to an app subnet 1126 that can be contained in a data plane app tier 1146 that can be contained in a container egress VCN 1168. Respective secondary VNICs 1172(1)-(N) can facilitate communication between the untrusted app subnet(s) 1162 contained in the data plane VCN 1118 and the app subnet contained in the container egress VCN 1168. The container egress VCN can include a NAT gateway 1138 that can be communicatively coupled to public Internet 1154 (e.g., public Internet 854 of FIG. 8).

The Internet gateway 1134 contained in the control plane VCN 1116 and contained in the data plane VCN 1118 can be communicatively coupled to a metadata management service 1152 (e.g., the metadata management service 852 of FIG. 8) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively couple to cloud services 1156.

In some examples, the pattern illustrated by the architecture of block diagram 1100 of FIG. 11 may be considered an exception to the pattern illustrated by the architecture of block diagram 1000 of FIG. 10 and may be desirable for a customer of the IaaS provider if the IaaS provider cannot directly communicate with the customer (e.g., a disconnected region). The respective containers 1167(1)-(N) that are contained in the virtual machines 1166(1)-(N) for each customer can be accessed in real-time by the customer. The containers 1167(1)-(N) may be configured to make calls to respective secondary VNICs 1172(1)-(N) contained in app subnet(s) 1126 of the data plane app tier 1146 that can be contained in the container egress VCN 1168. The secondary VNICs 1172(1)-(N) can transmit the calls to the NAT gateway 1138 that may transmit the calls to public Internet 1154. In this example, the containers 1167(1)-(N) that can be accessed in real-time by the customer can be isolated from the control plane VCN 1116 and can be isolated from other entities contained in the data plane VCN 1118. The containers 1167(1)-(N) may also be isolated from resources from other customers.

In other examples, the customer can use the containers 1167(1)-(N) to call cloud services 1156. In this example, the customer may run code in the containers 1167(1)-(N) that requests a service from cloud services 1156. The containers 1167(1)-(N) can transmit this request to the secondary VNICs 1172(1)-(N) that can transmit the request to the NAT gateway that can transmit the request to public Internet 1154. Public Internet 1154 can transmit the request to LB subnet(s) 1122 contained in the control plane VCN 1116 via the Internet gateway 1134. In response to determining the request is valid, the LB subnet(s) can transmit the request to app subnet(s) 1126 that can transmit the request to cloud services 1156 via the service gateway 1136.

It should be appreciated that IaaS architectures 800, 900, 1000, 1100 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

FIG. 12 illustrates an example computer system 1200, in which various embodiments may be implemented. The computer system 1200 may be used to implement any of the computer systems described above. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In certain embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1200 may include a storage subsystem 1218 that includes software elements, shown as being currently located within a system memory 1210. System memory 1210 may store program instructions that are loadable and executable on processing unit 1204, as well as data generated during the execution of these programs.

Depending on the configuration and type of computer system 1200, system memory 1210 may be volatile (such as random access memory (RAM)) and/or non-volatile (such as read-only memory (ROM), flash memory, etc.) The RAM typically contains data and/or program services that are immediately accessible to and/or presently being operated and executed by processing unit 1204. In some implementations, system memory 1210 may include multiple different types of memory, such as static random access memory (SRAM) or dynamic random access memory (DRAM). In some implementations, a basic input/output system (BIOS), containing the basic routines that help to transfer information between elements within computer system 1200, such as during start-up, may typically be stored in the ROM. By way of example, and not limitation, system memory 1210 also illustrates application programs 1212, which may include client applications, Web browsers, mid-tier applications, relational database management systems (RDBMS), etc., program data 1214, and an operating system 1216. By way of example, operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 1218 may also provide a tangible computer-readable storage medium for storing the basic programming and data constructs that provide the functionality of some embodiments. Software (programs, code services, instructions) that when executed by a processor provide the functionality described above may be stored in storage subsystem 1218. These software services or instructions may be executed by processing unit 1204. Storage subsystem 1218 may also provide a repository for storing data used in accordance with the present disclosure.

Storage subsystem 1218 may also include a computer-readable storage media reader 1220 that can further be connected to computer-readable storage media 1222. Together and, optionally, in combination with system memory 1210, computer-readable storage media 1222 may comprehensively represent remote, local, fixed, and/or removable storage devices plus storage media for temporarily and/or more permanently containing, storing, transmitting, and retrieving computer-readable information.

Computer-readable storage media 1222 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 1200.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program services, and other data for computer system 1200.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments, communications subsystem 1224 can include radio frequency (RF) transceiver components for accessing wireless voice and/or data networks (e.g., using cellular telephone technology, advanced data network technology, such as 3G, 4G, 5G or EDGE (enhanced data rates for global evolution), WiFi (IEEE 802.11 family standards, or other mobile communication technologies, or any combination thereof)), global positioning system (GPS) receiver components, and/or other components. In some embodiments, communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “including,” “having,” “including,” and “containing” are to be construed as open-ended terms (i.e., meaning “including, but not limited to,”) unless otherwise noted. The term “connected” is to be construed as a partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
estimating a number of threads to execute a batch job within a maximum completion time by executing a thread estimation algorithm, the executing the thread estimation algorithm comprising:
determining, using a machine learning (ML) model, a collection of one or more combinations, each of the one or more combinations comprising an estimated number of threads and an actual completion time for processing a total number of records of the batch job using the estimated number of threads, the actual completion time being less than or equal to the maximum completion time; and
saving the collection comprising the one or more combinations in a list of threads and completion times,
wherein the list of threads and completion times is used to select, based on a list of cloud virtual machines available for use, an optimal virtual machine or an optimal virtual machine combination, the optimal virtual machine or the optimal virtual machine combination being capable of executing the batch job within the maximum completion time.

2. The computer-implemented method of claim 1, wherein the executing the thread estimation algorithm further comprises:
for each number of threads among a plurality of numbers of threads between 2 and a predetermined maximum number of threads, iteratively performing:
determining a thread initialization time for processing the batch job, based on a current number of threads in a current iteration among a plurality of iterations, determining a process execution time using the maximum completion time and the thread initialization time,
providing, as an input to the ML model, the process execution time,
based on the input process execution time, obtaining, as an output of the ML model, a predicted number of records to be processed by the current number of threads,
determining whether the predicted number of records is greater than or equal to an expected number of records processable using the current number of threads, and
if the predicted number of records is greater than or equal to the expected number of records, determining, by using the ML model, the actual completion time to process the expected number of records, and saving, in the list of threads and completion times, the current number of threads in correspondence to the actual completion time of the batch job, wherein the current number of threads corresponds to the estimated number of threads of the current iteration, and
outputting the list of threads and completion times based on the plurality of iterations performed for the plurality of numbers of threads.

3. The computer-implemented method of claim 2, wherein the determining, by using the ML model, the actual completion time to process the expected number of records comprises:
providing, as an input to the ML model, the expected number of records to be processed in the current iteration, the expected number of records being calculated by dividing the total number of records by the current number of threads;
obtaining, as an output the ML model, a running time corresponding to the expected number of records; and
calculating the actual completion time by adding the thread initialization time to the running time output by the ML model.

4. The computer-implemented method of claim 1, further comprising:
selecting, from the list of cloud virtual machines, a plurality of most efficient single virtual machines to include a most efficient single virtual machine available for use in each of a plurality of configurations, each of the plurality of configurations corresponding to a number of cores per single virtual machine; and
arranging the plurality of most efficient single virtual machines in a list of the plurality of most efficient single virtual machines.

5. The computer-implemented method of claim 4, wherein the one or more combinations in the list of threads and completion times comprises one combination, and
the computer-implemented method further comprises:
determining a virtual machine collection comprising a plurality of efficient virtual resources, each of the plurality of efficient virtual resources includes one from among a single virtual machine and a virtual machine combination that are determined from the list of the plurality of most efficient single virtual machines, wherein each of the plurality of efficient virtual resources has a number of cores greater than or equal to a total number of cores to execute the batch job within the maximum completion time;
saving, in a list of efficient virtual resources, the plurality of efficient virtual resources in an order of decreasing efficiency; and
selecting the optimal virtual machine or the optimal virtual machine combination as a most efficient virtual resource from the list of efficient virtual resources.

6. The computer-implemented method of claim 5, wherein the selecting the optimal virtual machine or the optimal virtual machine combination as the most efficient virtual resource comprises determining one of the plurality of efficient virtual resources that has a lowest cost from the list of efficient virtual resources.

7. The computer-implemented method of claim 4, wherein:
the one or more combinations in the list of threads and completion times comprises a plurality of combinations, and
the computer-implemented method further comprises:
for each of the plurality of combinations, iteratively performing:
determining a virtual machine collection comprising a plurality of efficient virtual resources, each of the plurality of efficient virtual resources includes one from among a single virtual machine and a virtual machine combination that are determined from the list of the plurality of most efficient single virtual machines, wherein each of the plurality of efficient virtual resources has a number of cores greater than or equal to a total number of cores to execute the batch job within the maximum completion time, and
saving, in a list of efficient virtual resources, the plurality of efficient virtual resources in an order of decreasing efficiency; and
selecting, as the optimal virtual machine or the optimal virtual machine combination, a most efficient virtual resource based on a plurality of lists of efficient virtual resources obtained based on performing a plurality of iterations.

8. The computer-implemented method of claim 1, further comprising:
generating a training dataset using training data related to a historical batch job of a certain type; and
training an input model using the training dataset to generate the ML model for processing the batch job of the certain type, wherein the ML model comprises a regression model.

9. A computer program product tangibly embodied in one or more non-transitory machine-readable storage media including instructions configured to cause one or more data processors to perform the computer-implemented method of claim 1.

10. A computer system comprising:
one or more data processors; and
a non-transitory computer-readable medium storing instructions that, when executed by the one or more data processors, cause the one or more data processors to perform the computer-implemented method of claim 1.

11. A computer-implemented method comprising:
obtaining a list of threads and completion times for processing a batch job within a maximum completion time, the list of threads and completion times comprising a collection of one or more combinations, each of the one or more combinations comprising an estimated number of threads and an actual completion time for processing a total number of records of the batch job using the estimated number of threads; and
selecting, from a list of cloud virtual machines available for use, an optimal virtual machine or an optimal virtual machine combination using the list of threads and completion times, the optimal virtual machine or the optimal virtual machine combination being capable of executing the batch job within the maximum completion time.

12. The computer-implemented method of claim 11, wherein the selecting the optimal virtual machine or the optimal virtual machine combination further comprises:
selecting, from the list of cloud virtual machines, a plurality of most efficient single virtual machines to include a most efficient single virtual machine available for use in each of a plurality of configurations, each of the plurality of configurations corresponding to a number of cores per single virtual machine; and
arranging the plurality of most efficient single virtual machines in a list of the plurality of most efficient single virtual machines.

13. The computer-implemented method of claim 12, wherein the one or more combinations in the list of threads and completion times comprises one combination, and
the selecting the optimal virtual machine or the optimal virtual machine combination further comprises:
determining a virtual machine collection comprising a plurality of efficient virtual resources, each of the plurality of efficient virtual resources includes one from among a single virtual machine and a virtual machine combination that are determined from the list of the plurality of most efficient single virtual machines, wherein each of the plurality of efficient virtual resources has a number of cores greater than or equal to a total number of cores to execute the batch job within the maximum completion time;
saving, in a list of efficient virtual resources, the plurality of efficient virtual resources in an order of decreasing efficiency; and
selecting the optimal virtual machine or the optimal virtual machine combination as a most efficient virtual resource from the list of efficient virtual resources.

14. The computer-implemented method of claim 13, wherein the selecting the optimal virtual machine or the optimal virtual machine combination as the most efficient virtual resource comprises determining one of the plurality of efficient virtual resources that has a lowest cost from the list of efficient virtual resources.

15. The computer-implemented method of claim 12, wherein:
the one or more combinations in the list of threads and completion times comprises a plurality of combinations, and
the selecting the optimal virtual machine or the optimal virtual machine combination further comprises:
for each of the plurality of combinations, iteratively performing:
determining a virtual machine collection comprising a plurality of efficient virtual resources, each of the plurality of efficient virtual resources includes one from among a single virtual machine and a virtual machine combination that are determined from the list of the plurality of most efficient single virtual machines, wherein each of the plurality of efficient virtual resources has a number of cores greater than or equal to a total number of cores to execute the batch job within the maximum completion time, and
saving, in a list of efficient virtual resources, the plurality of efficient virtual resources in an order of decreasing efficiency; and
selecting, as the optimal virtual machine or the optimal virtual machine combination, a most efficient virtual resource based on a plurality of lists of efficient virtual resources obtained based on performing a plurality of iterations.

16. The computer-implemented method of claim 11, wherein the obtaining the list of threads and completion times further comprises:
for each number of threads among a plurality of numbers of threads between 2 and a predetermined maximum number of threads, iteratively performing:
determining a thread initialization time for processing the batch job, based on a current number of threads in a current iteration among a plurality of iterations,
determining a process execution time using the maximum completion time and the thread initialization time,
providing, as an input to a machine learning (ML) model, the process execution time,
based on the input process execution time, obtaining, as an output of the ML model, a predicted number of records to be processed by the current number of threads,
determining whether the predicted number of records is greater than or equal to an expected number of records processable using the current number of threads, and
if the predicted number of records is greater than or equal to the expected number of records, determining, by using the ML model, the actual completion time to process the expected number of records, and saving, in the list of threads and completion times, the current number of threads in correspondence to the actual completion time of the batch job, wherein the current number of threads corresponds to the estimated number of threads of the current iteration, and
outputting the list of threads and completion times based on the plurality of iterations performed for the plurality of numbers of threads.

17. The computer-implemented method of claim 16, wherein the determining, by using the ML model, the actual completion time to process the expected number of records comprises:
providing, as an input to the ML model, the expected number of records to be processed in the current iteration that is calculated by dividing the total number of records by the current number of threads;
obtaining, as an output the ML model, a running time corresponding to the expected number of records; and
calculating the actual completion time by adding the thread initialization time to the running time output by the ML model.

18. The computer-implemented method of claim 16, further comprising:
generating a training dataset using training data related to a historical batch job of a certain type; and
training an input model using the training dataset to generate the ML model for processing the batch job of the certain type, wherein the ML model comprises a regression model.

19. A computer program product tangibly embodied in one or more non-transitory machine-readable storage media including instructions configured to cause one or more data processors to perform the computer-implemented method of claim 11.

20. A computer system comprising:
one or more data processors; and
a non-transitory computer-readable medium storing instructions that, when executed by the one or more data processors, cause the one or more data processors to perform the computer-implemented method of claim 11.
